(19) United States
(12) Patent Application Publication
(10) Pub. No.: US 2016/0183579 A1
(43) Pub. Date: Jun. 30, 2016

(54) TASTE MODIFYING COMPOSITIONS

(71) Applicant: Celanese Sales Germany GmbH, Sulzbach (DE)

(72) Inventors: Johann WONSCHIK, Brevorde (DE); Clemens M. PUTTER, Zeeland (NL); Esther KEEPE, Schijndel (NL)

(21) Appl. No.: 14/978,212

(22) Filed: Dec. 22, 2015

Related U.S. Application Data
(60) Provisional application No. 62/095,869, filed on Dec. 23, 2014.
(60) Provisional application No. 62/168,006, filed on May 29, 2015.

(51) Int. Cl. A23L 1/236

(52) U.S. Cl. CPC A23L 1/2364; A23L 1/2361; A23L 1/2363; A23L 1/22091; A23L 1/22083; A23V 2002/00

(57) ABSTRACT

The invention relates to a sweetener/sweetness enhancer composition comprising a stevia-based sweetener and at least one of a compound having a balsamic note and the components thereof.

### CROSS-REFERENCE TO RELATED APPLICATIONS

This patent application claims priority to U.S. Provisional Patent Application No. 62/095,869, filed Dec. 23, 2014, and to U.S. Provisional Patent Application No. 62/168,006, filed May 29, 2015, the disclosures of which are incorporated herein by reference in their entireties.

### FIELD OF THE INVENTION

The present invention relates to unique sweetener/sweetness enhancer compositions and taste modifier compositions. More specifically, the present invention relates to sweetener/sweetness enhancer compositions comprising a compound having a balsamic note and a stevia-based sweetener. The invention further relates to methods of using the sweetener/sweetness enhancer compositions, methods of making the sweetener/sweetness enhancer compositions, and to consumable products containing the sweetener/sweetness enhancer compositions.

### BACKGROUND OF THE INVENTION

Consumable products with a high content of sugar, e.g., sucrose (saccharose), glucose, fructose, and mixtures thereof, are often desirable to consumers. It is commonly known, however, that consuming food high in sucrose/fructose content can greatly increase blood sugar level, lead to the formation of fatty deposits (caused by fructose), and ultimately result in health problems such as childhood obesity, type II diabetes, and related illnesses. As such, it is desirable to reduce the sucrose/fructose content of consumable products. One way to reduce sucrose/fructose content is to replace at least a portion of the sucrose/fructose in a consumable product with one or more low-calorie or non-calorie high-intensity sweeteners/sweetness enhancers. These high-intensity sweeteners/enhancers provide sweetnesses significantly greater than those of sugar. One group of high intensity sweeteners are stevia-based sweeteners.

Unlike conventional sugars, however, many of the non-calorie or low-calorie sweeteners have unpleasant taste features, e.g., off-tastes, aftertastes, and/or lingering sweetness. These taste features negatively affect the overall taste of the respective consumable product to which they are added. In some cases where these sweeteners are used in beverages, e.g., sweet, calorie-free, or very low calorie drinks, the sweeteners may exhibit unpleasant secondary taste impressions and/or aftertastes and may lower the sensory acceptance. For example, stevia-based sweeteners may have a bitter or licorice aftertaste. Also, stevia-based sweeteners are known to have a slower onset and a longer duration (as compared to sugar).

The unpleasant taste features of sweeteners/sweetness enhancers often require taste modifying. Many taste modifier substances are known. However, although many conventional taste modifier substances may partially modify unpleasant taste features of sweeteners or sweetness enhancers, the effectiveness of many of these substances is limited. In some cases, the use of conventional taste modifier substances may lead to additional unpleasant taste features. Importantly, most taste modifier substances do not work with all sweeteners/sweetness enhancers. And the effects of one taste modifier substance on one sweetener/sweetness enhancer cannot be extrapolated onto another entirely different sweetener/sweetness enhancer. Thus, it is surprising to find a particular combination of a taste modifier and a sweetener/sweetness enhancer that provides a synergistic combination of features including high intensity sweetness and paucity of unpleasant taste features.

Even in view of conventional taste modifier technology, there is a need for improved low- or non-calorie sweetener/sweetness enhancer compositions that provide sweetness to consumable products without adding sugar.

### SUMMARY OF THE INVENTION

In one embodiment, the invention relates to a process for modifying the taste features of stevia-based sweetener in a sweetener/sweetness enhancer composition, the process comprising: adding to the stevia-based sweetener at least one of a compound having a balsamic note and the components thereof (“balsamic compound”) to produce a modified sweetener/sweetness enhancer composition. The process may further comprise the step of determining a threshold limit for the balsamic compound relative to a solution comprising the solvent and the balsamic compound, wherein the threshold limit is the amount below which a modifying effect of the balsamic compound is undetectable in the solution. The adding step may comprise adding the stevia-based sweetener and the balsamic compound, in an amount below the threshold amount, to produce the modified sweetener/sweetness enhancer composition and may modify the taste features of the stevia-based sweetener in the sweetener/sweetness enhancer composition.

The invention may also relate to a sweetener/sweetness enhancer composition, comprising stevia-based sweetener and a balsamic compound, and the balsamic compound may be present in an amount below the threshold limit. In some cases, the balsamic compound is present in an amount ranging from 0.01 wppm to 10 wt %. The composition may further comprises a plant extract, e.g., a plant extract selected from the group consisting of: geranium extract, pimento berry oil, grapefruit extract, tangerine extract, lemon extract, lime extract, orange extract, basil extract, sage extract, rosemary extract, pine extract, sandalwood oil, bay extract, chamomile extract, fennel extract, rose extract, thyme extract, fenugreek extract, anise extract, jasmine extract, caraway oil, cassia oil ginger oil, and combinations thereof. The composition may further comprise an amino acid, e.g., an amino acid selected from the group consisting of: alanine, leucine, glycine, aspartic acid, lysine monohydrate, threonine, isoleucine, tyrosine, methionine, proline, serine, valine, glutamic acid, and combinations thereof. The composition may further comprise a lactone, e.g., a lactone selected from the group consisting of massiolactone, decalactone, dodecalactone, and mixtures thereof.

The invention may also relate to a process for making a sweetener/sweetness enhancer composition, the process comprising the step of combining stevia-based sweetener and a balsamic compound to produce the sweetener/sweetness enhancer composition, and optionally comprising the step of determining a threshold limit for the balsamic compound relative to a solution comprising the solvent and the balsamic compound. The invention may also relate to a process for making a liquid sweetener/sweetness enhancer composition comprising the steps of dissolving in a solvent a sweetener/sweetness enhancer composition comprising stevia-based sweetener and a balsamic compound to form the liquid sweetener/sweetness enhancer composition. The invention may also relate to a process for making a beverage composition comprising providing a potable liquid comprising: flavoring and water adding to the potable liquid a sweetener/sweetness enhancer composition comprising stevia-based sweetener; and a balsamic compound. The beverage composition may have a pH ranging from 2.5 to 3.3 and may comprise the balsamic compound in an amount ranging from 0.001 wppb to 110 wppm. The beverage composition my comprise the potable liquid comprising flavoring and water and the sweetener/sweetness enhancer composition.

The invention may also relate to the use of at least one of a balsamic compound to modify the taste features of stevia-based sweetener. The invention may also relate to a taste modifier composition comprising a balsamic compound and a plant extract. The balsamic compound may be present in an amount ranging from 0.05 wt % to 10 wt % or in an amount ranging from 0.01 wppm to 20 wppm and the composition further comprises at least 2 plant extracts. In some cases, the plant extract is present in an amount ranging from 0.09 wt % to 50 wt %. The composition may further comprise an amino acid, e.g., at least 2 amino acids and the amino acid may be present in an amount ranging from 0.008 wt % to 20 wt %. The composition may further comprise a lactone, e.g., at least 2 lactones and the lactone may be present in an amount ranging from 0.006 wt % to 20 wt %. The composition may further comprise an ester having a molecular weight greater than 200 and/or maltol or a maltol derivative and/or a carbonyl compound and/or sodium chloride and/or trehalose. In some cases, the composition comprises the balsamic compound present in an amount ranging from 0.05 wt % to 10 wt %; the plant extract present in an amount ranging from 0.09 wt % to 50 wt %; the amino acid present in an amount ranging from 0.008 wt % to 0.2 wt %; and the lactone present in an amount ranging from 0.006 wt % to 0.12 wt %. In some cases the composition comprises the balsamic compound present in an amount ranging from 0.01 wppm to 20 wppm; the plant extract present in an amount ranging from 0.09 wt % to 50 wt %; the amino acid present in an amount ranging from 0.008 wt % to 0.2 wt %; and the lactone present in an amount ranging from 0.006 wt % to 0.12 wt %. In some cases, the composition comprises: the plant extract present in an amount ranging from 0.09 wt % to 50 wt %; the amino acid present in an amount ranging from 0.008 wt % to 20 wt %; the lactone present in an amount ranging from 0.006 wt % to 20 wt %; the ester having a molecular weight greater than 200 present in an amount ranging from 0.001 wt % to 10 wt %; a bitter blocker present in an amount ranging from 0.15 wt % to 55 wt %; maltol present in an amount ranging from 0.1 wt % to 85 wt %; and the carbonyl compound present in an amount ranging from 0.0005 wt % to 10 wt %.

### DETAILED DESCRIPTION OF THE INVENTION

### Sweetener/Sweetness Enhancer Compositions

The present invention relates to a unique combination of a stevia-based sweetener and at least one of a compound having a balsamic note and the components thereof (a “balsamic compound”) or a stevia-based sweetener and a taste modifier composition comprising a balsamic compound. A taste modifier composition may comprise the balsamic compound and other optional taste modifiers (but no stevia-based sweetener). A sweetener/sweetness enhancer composition is formed by the combination of a stevia-based sweetener and balsamic compound (either alone or as a component in the taste modifier composition). As noted above, sweeteners/sweetness enhancers are known to have unpleasant taste features, e.g., off-tastes, aftertastes, and/or lingering sweetness. Stevia-based sweeteners are known to have a bitter or licorice aftertaste and to have a slower onset and longer duration (as compared to sugar). While many conventional taste modifier substances have been utilized in combination with stevia-based sweeteners in attempts to modify the (unpleasant) taste features thereof), these taste modifier substances have been found to be ineffective in reducing or eliminating the unpleasant taste features.

It has now been discovered that a compound having a balsamic note synergistically eliminates (or significantly reduces) the unpleasant taste features associated with a stevia-based sweetener (without providing (additional) unpleasant taste features). For example, the unexpected effect of the balsamic compounds reduces the bitter/licorice taste and/or exceedingly long lasting taste impressions that are typically exhibited by stevia-based sweeteners. This finding is surprising because most balsamic compounds have been found to have little or no effect on many other sweeteners/sweetness enhancers, e.g., thaumatin, aspartame, sodium cyclamate, sodium saccharine. That is to say, balsamic compounds, although known, e.g. in perfumery, are not known to be effective sweetener/sweetness enhancer taste modifiers for (most) sweeteners/sweetness enhancers. And there is little or no teaching that high intensity sweeteners such as stevia-based sweeteners would be useful to improve the performance of general perfumery compounds. The surprising and unexpected results shown by the combination of balsamic compounds and stevia-based sweeteners could not be predicted based on the known modification potential of most balsamic compounds (on other sweeteners), which has been shown to be poor. In fact, as shown in the Examples, balsamic compounds have been found to exacerbate the unpleasant taste features or to decrease the sweetness of other sweeteners/sweetness enhancers. Thus, the synergistic effects that the balsamic compounds have on stevia-based sweeteners are surprising and unexpected.

In addition, when the balsamic compound is combined with other components, e.g., a plant extract, an amino acid, a bitter blocking agent, maltol, and/or a lactone, the resulting taste modifier composition demonstrates a synergistic effect that is significantly better than should be expected based on the taste modifying capabilities of the components individually. In fact, as shown in the Examples, when utilized individually, the plant extract, the amino acid, the lactone, the bitter blocking agent, and the maltol show limited ability, if any, to modify the aforementioned unpleasant taste features of stevia-based sweeteners.

The sweetener/sweetness enhancer composition, in one embodiment, comprises a stevia-based sweetener and the taste modifier composition, which comprises the balsamic compound and may further comprise multiple other components, e.g., multiple plant extracts, multiple amino acids, and/or multiple lactones. In some embodiments, the taste modifier composition may further comprise multiple plant extracts, multiple bitter blocking agents, and/or maltol (or maltol derivatives).

Stevia-based sweeteners are generally well known. In some cases, stevia-based sweeteners are derived from the plant species Stevia rebaudiana. Some active compounds of stevia are referred to as steviol glycosides, e.g., stevioside and rebaudioside. Exemplary stevia-based sweeteners include (but are not limited to) stevia, steviolbioside, stevioside, other steviol glycosides, e.g., steviol 13 O-β-D-glycoside, dulcoside, rebaudiosides A-H, rubusoside, stevioside, steviolbiosides, suaviosides A, B and G-J. In one embodiment, the stevia-based sweetener comprises at least one sweetener selected from the group consisting of steviosides and rebaudiosides, e.g., rebaudiosides A-H.

In some cases, the combination of the balsamic compound and multiple other optional components in the taste modifier composition results in a synergistic improvement in overall taste quality of the sweetener/sweetness enhancer composition. For example the addition of at least two other components, e.g., at least three other components, or at least four other components, to the sweetener/sweetness enhancer composition provides an increase in overall taste quality that is much greater than the expected additive amount. For example, a first sweetener/sweetness enhancer composition comprises a stevia-based sweetener and a balsamic compound may have an overall taste quality that is represented by 100, and one other component, when tested individually, may yield an overall taste quality improvement of 10. Surprisingly, when the other component is included in the sweetener/sweetness enhancer composition (in an appropriately weighted amount), the resultant sweetener/sweetness enhancer composition demonstrates an overall taste quality of 120, which is significantly higher than the expected value of 110, which is the expected additive increase, i.e., 100+10=110. The overall taste quality of the sweetener/sweetness enhancer composition comprising the other component(s) is much greater than the overall taste quality of the sweetener/sweetness enhancer composition that does not comprise other component, e.g., two fewer other components or three fewer other components. Such synergistic results could not be predicted based on known values.

In one embodiment, the taste modifier composition (and the resultant sweetener/sweetness enhancer composition) may comprise at least two plant extracts, e.g., at least three plant extracts, at least four plant extracts, at least five plant extracts, at least seven plant extracts, or at least ten plant extracts. The overall taste quality of this sweetener/sweetness enhancer composition is significantly greater than the overall taste quality of a sweetener/sweetness enhancer composition comprising one fewer plant extract, e.g., two fewer plant extracts or three fewer plant extracts.

In one embodiment, the taste modifier composition (and the resultant sweetener/sweetness enhancer composition) may comprise at least two amino acids, e.g., at least three amino acids, at least four amino acids, at least five amino acids, at least seven amino acids, or at least ten amino acids. The overall taste quality of this sweetener/sweetness enhancer composition is significantly greater than the overall taste quality of a sweetener/sweetness enhancer composition comprising one fewer amino acid, e.g., two fewer amino acids or three fewer amino acids.

In one embodiment, the taste modifier composition (and the resultant sweetener/sweetness enhancer composition) may comprise at least two lactones, e.g., at least three lactones, at least four lactones, at least five lactones, at least seven lactones, or at least ten lactones. The overall taste quality of this sweetener/sweetness enhancer composition is significantly greater than the overall taste quality of a sweetener/sweetness enhancer composition comprising one fewer lactones, e.g., two fewer components or three other components.

In one embodiment, the taste modifier composition (and the resultant sweetener/sweetness enhancer composition) may comprise at least two bitter blocking agents, e.g., at least three bitter blocking agents, at least four bitter blocking agents, at least five bitter blocking agents, at least seven bitter blocking agents, or at least ten bitter blocking agents. The overall taste quality of this sweetener/sweetness enhancer composition is significantly greater than the overall taste quality of a sweetener/sweetness enhancer composition comprising one fewer bitter blocking agents, e.g., two fewer bitter blocking agents or three fewer bitter blocking agents.

Taste modifier compositions (and sweetener/sweetness enhancer compositions) comprising multiple numbers of other components, e.g., high molecular weight esters, carbonyl compounds, sodium chloride, trehalose, and/or dimethylanthranilate, are also contemplated.

In one embodiment, the invention relates to a process for modifying the taste features of a stevia-based sweetener in a sweetener/sweetness enhancer composition. The sweetener/sweetness enhancer composition may comprise a stevia-based sweetener and the process may comprise the step of adding to the stevia-based sweetener at least one of a compound having a balsamic note and the components thereof to produce a modified sweetener/sweetness enhancer composition.

The balsamic compound, in some embodiments, is present in an amount below a threshold limit. The threshold limit may be determined relative to a solution comprising solvent and the balsamic compound. And the threshold limit may be the amount below which a modifying effect of the balsamic compound is undetectable in the solution, e.g. an amount that is untasteable. The lack of a modifying effect, in some cases, may be interpreted as meaning that the taste of the solution without the component is the same as the taste of the solution with the component added. Once the threshold limit is determined, the balsamic compound may be added to the stevia-based sweetener in an amount below the threshold limit. Although the balsamic compound is present in the sweetener/sweetness enhancer composition in an amount below which a modifying effect is expected to be detected, the resultant sweetener/sweetness enhancer composition unexpectedly has an improved overall taste quality. The improvement is unexpected because the balsamic compound is present in an amount so small that it would not be expected to have any effect at all, e.g., an amount below the threshold limit. Nevertheless, the addition of the balsamic compound to the stevia-based sweetener modifies the taste features of the stevia-based sweetener. As one example, the threshold limit may be determined by preparing solutions each having decreasing levels of balsamic compound concentration, then tasting the solutions in decreasing order, e.g., using a tasting panel, until the balsamic compound is undetectable.

It is also contemplated that the determination of a threshold limit and the addition of a particular component in an amount below the threshold limit, may be utilized with components other than the balsamic compound.

In addition to the taste modifier and sweetener/sweetness enhancer compositions, the present invention also relates to a process for making a sweetener/sweetness enhancer composition. The process comprises the step of combining a stevia-based sweetener and the balsamic compound to produce the sweetener/sweetness enhancer composition. In some cases, the sweetener/sweetness enhancer composition with the balsamic compound added thereto may be referred to as a modified sweetener/sweetness enhancer composition. The combining may comprise combining the stevia-based sweetener and the balsamic compound in an amount below a threshold amount, which may be determined as discussed herein. As a result of the addition of the balsamic compound to the stevia-based sweetener, the taste features of the stevia-based sweetener in the sweetener/sweetness enhancer composition are modified, e.g., improved.

The present invention, in some embodiments, also relates to a process for making a liquid sweetener/sweetness enhancer composition. The process comprises the step of dissolving in a solvent the (modified) sweetener/sweetness enhancer composition to form the liquid sweetener/sweetness enhancer composition. In one embodiment, the stevia-based sweetener is dissolved in the solvent to form a solution, then the taste modifier composition, e.g., the balsamic compound, is added to and/or dissolved in the solution. In a separate embodiment, the balsamic compound is dissolved in the solvent to form a solution, then the stevia-based sweetener is added to and/or dissolved in the solution. The balsamic compound may be present in the liquid sweetener composition in an amount below the threshold level, with respect to the stevia-based sweetener.

In some embodiments, the present invention relates to a process for making a beverage composition. The process comprises the steps of providing a potable liquid comprising flavoring and water and adding to the potable liquid the (modified) sweetener/sweetness enhancer composition. The resultant beverage comprises the potable liquid and the sweetener/sweetness enhancer composition, e.g., a stevia-based sweetener and the taste modifier composition. The balsamic compound may be present in the beverage composition in an amount below the threshold level of the balsamic compound (as may be calculated as discussed above). In the beverage composition, the balsamic compound may be present in an amount ranging from 0.001 wppb to 110 wppm, e.g., from 0.1 wppb to 100 wppm, from 0.01 wppm to 100 wppm, from 0.01 wppm to 10 wppm, or from 0.1 wppm to 10 wppm. The beverage composition, as formed, may have a pH ranging from 2.5 to 3.3, e.g., from 2.7 to 3.1.

In one embodiment, the present invention relates to the use of the balsamic compound to modify the taste features of a stevia-based sweetener.

As used herein, the term “off-taste” means any taste of a sweetener, a sweetness enhancer or a consumable product, e.g., a food or beverage, that is perceived in the oral cavity on or after consumption thereof and that can stay there for a few minutes. Off-tastes include but are not limited to acidic, astringent, bitter, liquorice, metallic or throat-burning.

As used herein, the term “aftertaste” means any taste of a sweetener, a sweetness enhancer or a consumable product, e.g., a food or beverage, that is perceived in the oral cavity after the sweetener, the sweetness enhancer or the consumable product is removed from the oral cavity, e.g., by swallowing or disgorging. The aftertaste may remain in the oral cavity for example, for a few minutes or a few hours. Unpleasant aftertastes include but are not limited to bitter and/or astringent aftertastes.

As used herein, the term “lingering sweetness” means a very long-lasting sweetening effect of a sweetener, a sweetness enhancer or a consumable product, e.g., a food or beverage, that is perceived in the oral cavity after the sweetener, the sweetness enhancer or the consumable product is removed from the oral cavity by swallowing or disgorging. The lingering sweetness may remain in the oral cavity for example, for a few minutes or a few hours.

The term “sweetener/sweetness enhancer” means sweetener(s) and/or sweetness enhancer(s). As an example, a sweetener/sweetness enhancer composition may comprise a sweetener, a sweetness enhancer, or both a sweetener and a sweetness enhancer.

As used herein, the term “rich taste” means an impression of creaminess, milk fattiness and/or sweetness of a consumable product that is perceived in the oral cavity on or after consumption of a consumable product.

### Balsamic Compound

Compounds having a balsamic note are well known in the fragrance/perfumery milieu. Although these balsamic compounds are known in perfumery, however, there is very little teaching relating to the use of balsamic compounds, or perfumery compounds generally, in combination with high intensity sweeteners and/or sweetness enhancers. Specifically, there is no teaching that balsamic compounds are capable of providing surprising taste-modifying effects to sucralose in particular. Likewise, there is little or no teaching that high intensity sweeteners such as sucralose would be useful to improve the performance of general perfumery compounds.

Balsamic notes, in some cases, can be described as sweet, soft and warm, and may be related to the use of balsams and resins. Many Oriental perfumes in particular are characterized by balsamic ingredients. Balsam is a term that may be used to describe the gummy resin from various trees and shrubs. Balsams, generally speaking, are trickly materials, including but not necessarily being plant secretions, e.g., from trees, from flower pods, bushy twigs (such as the Mediterranean rockrose). There are exceptions, however, and all compounds having a balsamic note must not originate from plant secretions.

Exemplary balsamic compounds include benzoin gum, e.g., from Styrax Tonkiniensis; benzoin Siam; benzoin Sumatra; benzoin resinode; benzoin absolute; Peru balsam, e.g., from the Myroxylon or Quina/Balsamo; Tolu balsam; cistus labdanum, e.g., from the rockrose bush; opoponax, e.g., from the Opopanax chironium herb; frankincense/olibanum, e.g., from the Boswellia carteri tree; myrrh gum; fir; birch tar; elemi; and styrax, e.g., from the Liquidambar Orientalis tree. This listing is merely exemplary and is not meant to limit the scope of the term “balsamic compound.”

In some cases, a known balsamic compound may be employed. Thus, the production or provision of the balsamic compound may entail purchasing and using an off-the-shelf balsamic compound. In one embodiment, the production or provision of the balsamic compound may comprise testing a plurality of compounds to determine which compounds have a balsamic note. The compounds determined by such a method may then be employed in the sweetener/sweetness enhancer compositions.

In some embodiments, the term “balsamic compound,” as used herein, also includes the components of compounds having a balsamic note. The components of many of the compounds having a balsamic note are known. In some cases, the components of compounds having a balsamic note may be determined via GC analysis or by other well-known methods. As another example, the components of benzoin include limonene, methylbenzoate, ethylbenzoate, benzoic acid, 2-hydroxyacetophenone, 4-hydroxybenzaldehyde, dihydroeugenol, eugenol, 4-(ethoxymethyl)-2-methoxyphenol, acetovanillone, homovanillylalcohol, ethyl-2-benzoylhydrazinecarboxylate, homovanillylic acid, beta-methoxycinnamic acid, methyl homovanillate, 4-hydroxy-2-methoxycinnamaldehyde, ethyl homovanillate.

In one embodiment, the balsamic compound is present in an amount ranging from from 0.01 wppm to 10 wt %. Additional exemplary ranges are provided herein.

### Plant Extract

The taste modifier composition may further comprise a plant extract, and the plant extract may vary widely. Generally speaking, the plant extract may be any component that is derived from a plant source. The plant extract may include but is not limited to oils, resins, rosins, oleoresins, resinodes, crystals, and/or powders that may be extracted from the plant source.

The plant extract, in one embodiment, may be selected from the group consisting of geranium extract, pimento berry oil, grapefruit extract, tangerine extract, lemon extract, lime extract, orange extract, basil extract, sage extract, rosemary extract, pine extract, sandalwood oil, bay extract, chamomile extract, fennel extract, rose extract, thyme extract, fenugreek extract, anise extract, jasmine extract, caraway oil, cassia oil ginger oil, and combinations thereof.

The plant extracts discussed herein are commercially available or can be prepared by the skilled person based on general knowledge. The plant extracts discussed herein may be of synthetic or of natural origin, preferably of natural origin.

In some embodiments, the plant extracts as used herein, also include the individual compounds that make up the plant extracts, e.g., the compounds that make up cassia oil or caraway oil. The components of many of the plant extracts are known. And the components may be added individually to arrive at the inventive taste modifier compositions.

### Amino Acid

The taste modifier composition may further comprise an amino acid, and the amino acid may vary widely. In one embodiment, the amino acid may be selected from the group consisting of alanine, leucine, glycine, aspartic acid, lysine monohydrate, threonine, isoleucine, tyrosine, methionine, proline, serine, valine and glutamic acid.

In one embodiment, the amino acid may be selected from the group consisting of L-alanine, L-leucine, glycine, L-aspartic acid, L-lysine monohydrate, L-threonine, L-isoleucine, L-tyrosine, L-methionine, L-proline, L-serine, L-valine and L-glutamic acid.

Preferably, the amino acid amino acid may be selected from the group consisting of leucine, e.g., isoleucine, tyrosine, proline, serine, valine and glutamic acid. Other amino acids may include any natural amino acids, artificial amino acid derivatives and physiologically acceptable salts and hydrates thereof. The natural amino acids may be chosen from the standard amino acids selected from the group consisting of alanine, arginine, asparagine, aspartic acid, cysteine, glutamine, glycine, histidine, lysine, methionine, phenylalanine, threonine, tryptophan, selenocysteine and pyrrolysine and physiologically acceptable salts and hydrates thereof. These other amino acids may include any possible isomers, comprising L- and D-amino acids, R- and S-enantiomers, mixtures and racemates thereof, preferably L-amino acids.

The amino acids discussed herein are commercially available or can be prepared by the skilled person based on general knowledge. The amino acids discussed herein may be of synthetic or of natural origin, preferably of natural origin.

### Lactone

The taste modifier composition may further comprise a lactone and the lactone may vary widely. In one embodiment, the lactone contains from 6 to 18 carbon atoms, preferably from 8 to 14 carbon atoms. The lactone may have a boiling point of between 150° C. and 500° C., preferably between 190° C. and 400° C.

In one embodiment, the lactone comprises a saturated or an unsaturated delta-lactone. In one embodiment, the lactone comprises a delta-lactone of the formulae (I) or (II).

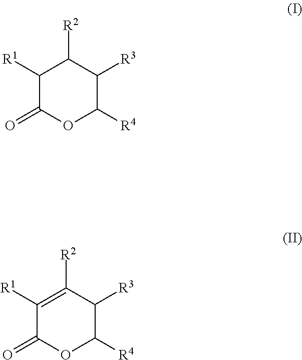

wherein said lactone does not contain more than 18 carbon atoms, preferably from 8 to 14 carbon atoms, and wherein R¹, R², R³ and R⁴ are identical or different and each is independently of the others hydrogen, hydroxy, C₁-C₁₀ alkyl, C₁-C₁₀alkoxy or C₂-C₁₀ alkenyl.

Preferably, the lactone is selected from the group consisting of: pentano-1,5-lactone, hexano-1,5-lactone, heptano-1,5-lactone, octano-1,5-lactone, nonano-1,5-lactone, decano-1,5-lactone, undecano-1,5-lactone, dodecano-1,5-lactone, tridecano-1,5-lactone, tetradecano-1,5-lactone, pentadecano-1,5-lactone, hexadecano-1,5-lactone, pent-2-eno-1,5-lactone, hex-2-eno-1,5-lactone, hept-2-eno-1,5-lactone, oct-2-eno-1,5-lactone, non-2-eno-1,5-lactone, dec-2-eno-1,5-lactone, undec-2-eno-1,5-lactone, dodec-2-eno-1,5-lactone, tridec-2-eno-1,5-lactone, tetradec-2-eno-1,5-lactone, pentadec-2-eno-1,5-lactone, hexadec-2-eno-1,5-lactone, dec-5-eno-1,5-lactone, dec-6-eno-1,5-lactone, dec-7-eno-1,5-lactone, dec-8-eno-1,5-lactone, undec-5-eno-1,5-lactone, undec-6-eno-1,5-lactone, undec-7-eno-1,5-lactone, undec-8-eno-1,5-lactone, dodec-2-eno-1,5-lactone and nepetalactone.

In one embodiment, the lactone comprises a delta-lactone of the formulae (III) or (IV).

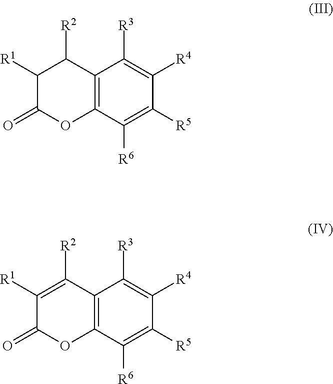

wherein said lactone does not contain more than 18 carbon atoms, preferably from 9 to 14 carbon atoms, and wherein R¹, R², R³, R⁴, R⁵ and R⁶ are identical or different and each is independently of the others hydrogen, hydroxy, C₁-C₆ alkyl, C₁-C₄ alkoxy or C₂-C₆ alkenyl.

Preferably, the lactone is selected from the group consisting of 6-methylcoumarin, 3,4-dihydrocoumarin, and 7-ethoxy-4-methylcoumarin.

In one embodiment, the lactone comprises a saturated or an unsaturated gamma-lactone.

In one embodiment, the lactone comprises a gamma-lactone of the formulae (V) or (VI)

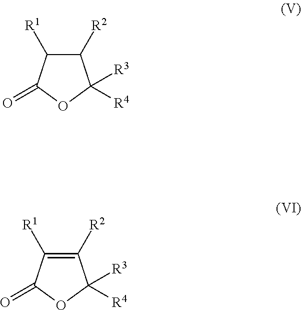

wherein said lactone does not contain more than 18 carbon atoms, preferably from 8 to 14 carbon atoms, and wherein R¹, R² and R³ are identical or different and each is independently of the others hydrogen, hydroxy, C₁-C₁₀ alkyl, C₁-C₁₀ alkoxy or C₂-C₁₀ alkenyl; and R⁴ ishydrogen, C₁-C₁₀ alkyl or C₂-C₁₀ alkenyl.

Preferably, the gamma-lactone is selected from the group consisting of: pentano-1,4-lactone, hexano-1,4-lactone, heptano-1,4-lactone, octano-1,4-lactone, nonano-1,4-lactone, decano-1,4-lactone, undecano-1,4-lactone, dodecano-1,4-lactone, tridecano-1,4-lactone, tetradecano-1,4-lactone, pentadecano-1,4-lactone, hexadecano-1,4-lactone, butyloctano-1,4-lactone, dodec-6-eno-1,4-lactone, dec-7-eno-1,4-lactone, cis-dec-7-eno-1,4-lactone, 2,7-dimethylocta-5(trans), 7-dieno-1,4-lactone, hex-2-eno-1,4-lactone, 3-methylnonano-1,4-lactone, 3-methyloctano-1,4-lactone, non-2-eno-1,4-lactone, 2-decen-1,4-lactone, dimethylnon-2-eno-1,4-lactone, 3-methyl gamma-decalactone, 4-methyl-5-hexen-1,4-olide, 4-hydroxyoctanoic acid lactone, 4-hydroxy-3-methyl octanoic acid lactone, 4-hydroxyundecanoic acid lactone and 4-hydroxy-2-hexanoic acid lactone.

In one embodiment, the lactone is selected from the group consisting of decalactone, dodecalactone, massoialactone, and mixtures thereof.

In one embodiment, the at least one lactone comprises a delta lactone and a gamma lactone, preferably the first lactone is a delta-lactone and the second lactone is a gamma-lactone.

Massoialactone is used herein is a known compound. Massoialactone, in one embodiment, comprises alkyl lactones derived from the bark of the Massoia tree (Cryptocaria massoia) which may be found throughout Malaysia. In other embodiments, the compounds may be found as a component of cane sugar molasses, cured tobacco and the essential oil of Sweet Osmanthus (Osmanthus fragrans). Exemplary synonyms for the massoialactone are (R)-5,6-dihydro-6-pentyl-2H-pyran-2-one, (R)-5-hydroxy-2-decenoic acid lactone, cocolactone, 5-pentylpent-2-en-5-olide, C-10 massoialactone and C-12 massoialactone. This listing of names is not meant to limit the scope of the invention. Preferably, C-10 massoialactone and/or C-12 massoialactone are used, with C-10 massoialactone being particularly preferred. As used herein, “massoialactone” may mean any possible enantiomers, e.g., the R- and the S-enantiomers, mixtures and racemates thereof. Preferably the C-10 massoialactone (R)-5,6-dihydro-6-pentyl-2H-pyran-2-one with the CAS registry number 51154-96-2 is used is used in the present invention. The massoialactone is commercially available and may be of synthetic or of natural origin. When naturally occurring massoialactone is employed the massoialactone is preferably used in its pure form. In one embodiment, massoialactone may be used in the form of massoialactone containing extracts or massoialactone enriched (fractions of) extracts. Preferably, massoialactone is of synthetic origin.

The lactones discussed herein are commercially available or can be prepared by the skilled person based on general knowledge. The lactones discussed herein may be of synthetic or of natural origin, preferably of natural origin.

As used herein, the term “C₁-C₈-alkyl” means a straight-chain or branched alkyl group with 1 to 8 carbon atoms, preferably a straight-chain or branched alkyl group with 1 to 6 carbon atoms and particularly preferred a straight-chain or branched alkyl group with 1 to 4 carbon atoms. Examples of straight-chain and branched C₁-C₈-alkyl groups include, but are not limited to, methyl, ethyl, propyl, isopropyl, butyl, isobutyl, tert.-butyl, the isomeric pentyls, the isomeric hexyls, the isomeric heptyls, the isomeric octyls, preferably methyl and ethyl and most preferred methyl.

As used herein, the term “C₁-C₁₀-alkyl” means a straight-chain or branched alkyl group with 1 to 10 carbon atoms, preferably a straight-chain or branched alkyl group with 1 to 6 carbon atoms and particularly preferred a straight-chain or branched alkyl group with 1 to 4 carbon atoms. Examples of straight-chain and branched C₁-C₁₀-alkyl groups include, but are not limited to, methyl, ethyl, propyl, isopropyl, butyl, isobutyl, tert.-butyl, the isomeric pentyls, the isomeric hexyls, the isomeric heptyls, the isomeric octyls, preferably methyl and ethyl and most preferred methyl.

As used herein, the term “C₁-C₈-alkoxy” means the group R′O—, wherein R′ is C₁-C₈-alkyl and has the meanings defined above. Examples of C₁-C₈-alkoxy groups include, but are not limited to, methoxy, ethoxy, n-propoxy, isopropoxy, n-butoxy, isobutoxy, sec.-butoxy and tert.-butoxy, preferably methoxy and ethoxy.

As used herein, the term “C₁-C₁₀-alkoxy” means the group R′O—, wherein R′ is C₁-C₁₀-alkyl and has the meanings defined above. Examples of C₁-C₁₀-alkoxy groups include, but are not limited to, methoxy, ethoxy, n-propoxy, isopropoxy, n-butoxy, isobutoxy, sec.-butoxy and tert.-butoxy, preferably methoxy and ethoxy.

As used herein, the term “C₂-C₈-alkenyl” alone or in combination means a straight-chain or branched hydrocarbon residue comprising an olefinic bond and 1 to 8, preferably 1 to 6, more preferably 1 to 4, carbon atoms. Examples of alkenyl groups include, but are not limited to, ethenyl, 1-propenyl, 2-propenyl, isopropenyl, 1-butenyl, 2-butenyl, 3-butenyl and isobutenyl. A preferred example is 2-propenyl.

### Bitter Blocking Agent

The taste modifier composition, in some embodiments, further comprises a bitter blocking agent, e.g., at least one bitter blocking agent, at least two bitter blocking agents, at least three bitter blocking agents, at least four bitter blocking agents, at least five bitter blocking agents, at least seven bitter blocking agents, or at least ten bitter blocking agents.

The bitter blocking agent may vary widely. In one embodiment, the bitter blocking agent is selected from the group consisting of a compound comprising a flavanonyl moiety, in particular a flavanone, a hydroxyflavanone, a dihydroxyflavanone or a trihydroxyflavanone; a compound comprising a quininyl moiety, in particular quinine, quinine bisulfate, quinine hydrochloride, quinine sulfate, hydroxyquinine; a compound comprising a purinyl moiety, in particular caffeine or theobromine; a compound comprising a saccharide acetate moiety, in particular glucose penta-acetate or sucrose octa-acetate; and benzyl diethyl-(2:6-xylyl-carbamoyl-methyl)-ammonium benzoate.

Preferably, the bitter blocking agent is a compound comprising a flavanoyl moiety selected from the group consisting of naringin, naringenin and naringin dihydrochalcone or a naringin containing extract, preferably being naringin.

Naringin as used herein is a known compound. Exemplary names for naringin are 7-[[2-O-(6-deoxy-α-L-mannopyranosyl)-β-D-glucopyranosyl]]oxy]-2,3-dihydro-5-hydroxy-2-(4-hydroxyphenyl)-4H-1-benzopyran-4-one (IUPAC name), naringoside, 4′,5,7-trihydroxyflavanone-7-rhamnoglucoside and 4′,5,7-trihydroxyflavanone-7-rutinoside. This listing of names is not meant to limit the scope of the invention. Preferably naringin with the CAS registry number 10236-47-2 is used in the present invention. Naringin is commercially available and may be of synthetic or of natural origin. When naturally occurring naringin is employed the naringin is preferably used in its pure form. In one embodiment, naringin extracted from Citrus paradisi may be used. In another embodiment, naringin may be used in the form of naringin containing extracts or naringin enriched (fractions of) extracts.

The bitter blocking agents are commercially available or can be prepared by the skilled person based on general knowledge. The bitter blocking agents may be of synthetic or of natural origin.

### Maltol

In one embodiment, the taste modifying composition further comprises maltol or a maltol derivative. Maltol is commercially available or can be prepared by the skilled person based on general knowledge. The maltol may be of synthetic or of natural origin, preferably of natural origin. In one embodiment, the maltol may have the chemical formula:

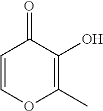

### Ester

The taste modifier composition, in some embodiments, may further comprise an ester, e.g., a high molecular weight ester. The ester may have a molecular weight greater than 200, e.g., greater than 300, or greater than 500. The taste modifier composition may comprise at least one of such esters, e.g., at least two such esters, at least three such esters, at least four such esters, at least five such esters, at least seven such esters, or at least ten such esters. In one embodiment, the ester is selected from the group consisting of alkylpalmitates, alkyl myristates, and/or alkyllaurates. In one embodiment, the ester is selected from the group consisting of butyl laurate, butyl myristate, propyl laurate, propyl myristate, ethylpalmitate, ethyllaurate, and combinations thereof. In one embodiment, the ester is selected from the group consisting of ethylpalmitate and/or ethyllaurate.

The high molecular weight esters discussed herein are commercially available or can be prepared by the skilled person based on general knowledge. The high molecular weight esters discussed herein may be of synthetic or of natural origin, preferably of natural origin.

### Carbonyl Compound

The taste modifier composition, in some embodiments, further comprises a carbonyl compound, e.g., at least one carbonyl compound, at least two carbonyl compounds, at least three carbonyl compounds, at least four carbonyl compounds, at least five carbonyl compounds, at least seven carbonyl compounds, or at least ten carbonyl compounds.

In one embodiment, the carbonyl compound contains from 7 to 18 carbon atoms, preferably from 7 to 14 carbon atoms. In one embodiment, the carbonyl compound has a boiling point of from 150° C. to 500° C., preferably from 190° C. to 400° C.

In one embodiment, the carbonyl compound is a carbonyl compound of the formula (VII)

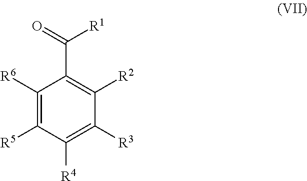

wherein said carbonyl compound does not contain more than 18 carbon atoms, preferably from 8 to 14 carbon atoms, and wherein R¹ is hydrogen, hydroxy, C₁-C₈ alkyl or C₂-C₈ alkenyl; and R², R³, R⁴, R⁵ and R⁶ are identical or different and each is independently of the others hydrogen, hydroxy, C₁-C₈ alkyl, C₁-C₈ alkoxy or C₂-C₈ alkenyl.

Preferably, in the carbonyl compound of the formula (VII)) at least one of R², R³, R⁴, R⁵ and R⁶ is hydroxy or methoxy.

Preferably, the carbonyl compound is selected from the group consisting of a compound comprising a vanillin moiety, in particular vanillin, ethyl vanillin, methyl vanillate, ethyl vanillate, vanillic acid, vanillin isobutyrate, ethyl vanillin isobutyrate, acetovanillone or 5-methoxyvanillin; a compound comprising a benzaldehyde moiety other than a vanillin moiety, in particular 4-hydroxybenzaldehyde, 2-methoxybenzaldehyde, 3-methoxybenzaldehyde, 4-methoxybenzaldehyde, 4-ethoxybenzaldehyde, 4-ethylbenzaldehyde, 2-hydroxy-4-methylbenzaldehyde, 2-methoxybenzoic acid, 3,4-dihydroxybenzaldehyde, 4-hydroxy-3,5-dimethoxybenzaldehyde, veratraldehyde, anis aldehyde, salicylaldehyde, 3-methoxy salicylaldehyde or 4-methoxy salicylaldehyde; a compound comprising a benzoic acid moiety, 3-methoxybenzoic acid, 4-methoxybenzoic acid, 2-hydroxybenzoic acid, 3-hydroxybenzoic acid, 4-hydroxybenzoic acid, ethyl 2-hydroxy-4-methylbenzoate or anisic acid; and a compound comprising an acetophenone moiety, in particular 2-hydroxyacetophenone, 3-hydroxyacetophenone or 4-hydroxyacetophenone.

Preferably, the carbonyl compound is selected from the group consisting of acetoin and 2,3-pentadione.

The carbonyl compounds of the formula (VII) are commercially available or can be prepared by the skilled person based on general knowledge. The carbonyl compounds of the formula (VII) may be of synthetic or of natural origin, preferably of natural origin.

### Sodium Chloride, Trehalose, and Dimethylanthranilate

The taste modifier composition may further comprise sodium chloride and/or trehalose and/or dimethyl anthranilate. These compounds are commercially available or can be prepared by the skilled person based on general knowledge. These components may be of synthetic or of natural origin, preferably of natural origin.

In one embodiment, the taste modifier composition comprises a plant extract, maltol, and a bitter blocker. The plant extract, the maltol, and the bitter blocker may be as discussed above. The taste modifier may further comprise a lactone, a high molecular weight ester, and amino acid, and/or a carbonyl compound. The lactone, the high molecular weight ester, the amino acid, and the carbonyl compound may be as discussed above. Preferably the plant extract comprises benzoin, e.g., benzoin absolute. The taste modifier composition may further comprise sodium chloride, trehalose, and/or dimethylanthranilate as discussed above.

### Preferred Taste Modifier Compositions

In one embodiment, the taste modifier composition comprises balsamic compounds, e.g., benzoin, e.g., benzoin absolute, balsam extract, e.g., tolu balsam resinode, sinensal, e.g., beta sinensal, trehalose, sodium chloride, maltol, naringin, delta dodecalactone, massoialactone, deltadecalactone, valine, acetoin, pimento berry oil, ethylpalmitate, sandalwood oil, proline, leucine, e.g., isoleucine, serine, tyrosine, glutamic acid, 2,3-pentadione, caraway oil, cassia oil, dimethylanthranilate, ethyllaurate, and ginger oil.

In one embodiment, the taste modifier composition comprises balsamic compound(s), e.g., benzoin, e.g., benzoin absolute, balsam extract, delta dodecalactone, massoialactone, deltadecalactone, valine, proline, leucine, e.g., isoleucine, serine, tyrosine, glutamic acid, caraway oil, cassia oil, ginger oil. This taste modifier composition may further comprise sodium chloride, trehalose, and/or dimethyl anthranilate.

In one embodiment, the taste modifier composition comprises balsamic compound(s), e.g., benzoin, e.g., benzoin absolute, balsam extract, maltol, naringin, caraway oil, cassia oil, ginger oil. This taste modifier composition may further comprise a lactone, a high molecular weight ester, a carbonyl compound, and/or an amino acid. This taste modifier composition may further comprise sodium chloride, trehalose, and/or dimethyl anthranilate.

In one embodiment, the balsamic compound is present in the taste modifier composition in an amount ranging from 0.05 wt % to 10 wt %, e.g., from 0.1 wt % to 5 wt %, or from 0.2 wt % to 3 wt %. In terms of lower limits, the balsamic compound may be present in the taste modifier composition in an amount at least 0.05 wt %, e.g., at least 0.1 wt %, or at least 0.2 wt %. In terms of upper limits, the balsamic compound may be present in the taste modifier composition in an amount less than 10 wt %, e.g., less than 5 wt %, or less than 3 wt %.

In one embodiment, the balsamic compound is present in the taste modifier composition in an amount ranging from 0.01 wppm to 20 wppm, e.g., from 0.05 wppm to 10 wppm, or from 0.1 wppm to 5 wppm. In terms of lower limits, the balsamic compound may be present in the taste modifier composition in an amount at least 0.01 wppm, e.g., at least 0.05 wppm, or at least 0.1 wppm. In terms of upper limits, the balsamic compound may be present in the taste modifier composition in an amount less than 20 wppm, e.g., less than 10 wppm, or less than 5 wppm.

In one embodiment, the balsamic compound is present in the taste modifier composition in an amount ranging from 0.01 wppm to 10 wt %, e.g., from 0.05 wppm to 5 wt %, or from 0.1 wppm to 3 wt %.

If a carrier were to be added to the taste modifier composition, weight percentage of the taste modification components would likewise be changed. The ranges and limits disclosed herein relate to the taste modifier without a carrier. The weight ranges including the carrier could be calculated by one of ordinary skill in the art.

In one embodiment, the plant extract is present in the taste modifier composition in an amount ranging from 0.09 wt % to 50 wt %, e.g., from 0.4 wt % to 40 wt %, or from 0.5 wt % to 25 wt %.

In one embodiment, the plant extract is present in the taste modifier composition in an amount ranging from 0.09 wt % to 2 wt %, e.g., from 0.4 wt % to 1.5 wt %, from 0.7 wt % to 1.2 wt %, or from 0.8 wt % to 1.1 wt %. In one embodiment, the plant extract is present in the taste modifier composition in an amount at least 0.09 wt %, e.g., at least 0.4 wt %, at least 0.7 wt %, or at least 0.8 wt %. In one embodiment, the plant extract is present in the taste modifier composition in an amount less than 2 wt %, e.g., less than 1.5 wt %, less than 1.2 wt %, or less than 1.1 wt %.

In one embodiment, the plant extract is present in the taste modifier composition in an amount ranging from 0.1 wt % to 15 wt %, e.g., from 0.5 wt % to 10 wt %, or from 2 wt % to 10 wt %. In one embodiment, the plant extract is present in the taste modifier composition in an amount at least 0.1 wt %, e.g., at least 0.5 wt %, or at least 2 wt %. In one embodiment, the plant extract is present in the taste modifier composition in an amount less than 15 wt %, e.g., less than 12 wt %, or less than 10.

In one embodiment, the plant extract is present in the taste modifier composition in an amount ranging from 1 wt % to 50 wt %, e.g., from 5 wt % to 40 wt %, or from 10 wt % to 30 wt %. In one embodiment, the plant extract is present in the taste modifier composition in an amount at least 1 wt %, e.g., at least 5 wt %, or at least 10 wt %. In one embodiment, the plant extract is present in the taste modifier composition in an amount less than 50 wt %, e.g., less than 40 wt %, or less than 30.

In one embodiment, the amino acid is present in the taste modifier composition in an amount ranging from 0.008 wt % to 20 wt %, e.g., from 0.04 wt % to 15 wt %, or from 0.07 wt % to 10 wt %.

In one embodiment, the amino acid is present in the taste modifier composition in an amount ranging from 0.008 wt % to 0.2 wt %, e.g., from 0.04 wt % to 0.14 wt %, from 0.06 wt % to 0.12 wt %, or from 0.07 wt % to 0.1 wt %. In one embodiment, the amino acid is present in the taste modifier composition in an amount at least 0.008 wt %, e.g., at least 0.04 wt %, at least 0.06 wt %, or at least 0.07 wt %. In one embodiment, the amino acid is present in the taste modifier composition in an amount less than 0.2 wt %, e.g., less than 0.14 wt %, less than 0.12 wt %, or less than 0.1 wt %.

In one embodiment, the amino acid is present in the taste modifier composition in an amount ranging from 0.01 wt % to 10 wt %, e.g., from 0.05 wt % to 7 wt %, from 0.1 wt % to 3 wt %, or from 0.2 wt % to 1 wt %. In one embodiment, the amino acid is present in the taste modifier composition in an amount at least 0.01 wt %, e.g., at least 0.05 wt %, at least 0.1 wt %, or at least 0.2 wt %. In one embodiment, the amino acid is present in the taste modifier composition in an amount less than 10 wt %, e.g., less than 7 wt %, less than 3 wt %, or less than 1 wt %.

In one embodiment, the amino acid is present in the taste modifier composition in an amount ranging from 0.1 wt % to 20 wt %, e.g., from 0.2 wt % to 10 wt %, from 0.3 wt % to 5 wt %, or from 1 wt % to 2 wt %. In one embodiment, the amino acid is present in the taste modifier composition in an amount at least 0.1 wt %, e.g., at least 0.2 wt %, at least 0.3 wt %, or at least 1 wt %. In one embodiment, the amino acid is present in the taste modifier composition in an amount less than 20 wt %, e.g., less than 10 wt %, less than 5 wt %, or less than 2 wt %.

In one embodiment, the lactone is present in the taste modifier composition in an amount ranging from 0.006 wt % to 20 wt %, e.g., from 0.03 wt % to 15 wt %, or from 0.05 wt % to 10 wt %.

In one embodiment, the lactone is present in the taste modifier composition in an amount ranging from 0.006 wt % to 0.12 wt %, e.g., from 0.03 wt % to 0.1 wt %, from 0.04 wt % to 0.08 wt %, or from 0.05 wt % to 0.07 wt %. In one embodiment, the lactone is present in the taste modifier composition in an amount at least 0.006 wt %, e.g., at least 0.03 wt %, at least 0.04 wt %, or at least 0.05 wt %. In one embodiment, the lactone is present in the taste modifier composition in an amount less than 0.12 wt %, e.g., less than 0.1 wt %, less than 0.08 wt %, or less than 0.07 wt %.

In one embodiment, the lactone is present in the taste modifier composition in an amount ranging from 0.01 wt % to 10 wt %, e.g., from 0.05 wt % to 7 wt %, from 0.1 wt % to 3 wt %, or from 0.2 wt % to 0.9 wt %. In one embodiment, the lactone is present in the taste modifier composition in an amount at least 0.01 wt %, e.g., at least 0.05 wt %, at least 0.1 wt %, or at least 0.2 wt %. In one embodiment, the lactone is present in the taste modifier composition in an amount less than 10 wt %, e.g., less than 7 wt %, less than 3 wt %, or less than 0.9 wt %.

In one embodiment, the lactone is present in the taste modifier composition in an amount ranging from 0.1 wt % to 20 wt %, e.g., from 0.2 wt % to 10 wt %, from 0.3 wt % to 5 wt %, or from 0.5 wt % to 1.6 wt %. In one embodiment, the lactone is present in the taste modifier composition in an amount at least 0.1 wt %, e.g., at least 0.2 wt %, at least 0.3 wt %, or at least 0.5 wt %. In one embodiment, the lactone is present in the taste modifier composition in an amount less than 20 wt %, e.g., less than 10 wt %, less than 5 wt %, or less than 1.6 wt %.

In one embodiment, if a bitter blocking agent is present in the taste modifier composition, the bitter blocking agent is present in an amount ranging from 0.15 wt % to 55 wt %, e.g., from 0.75 wt % to 45 wt %, or from 1 wt % to 35 wt %.

In one embodiment, if a bitter blocking agent is present in the taste modifier composition, the bitter blocking agent is present in an amount ranging from 0.15 wt % to 3 wt %, e.g., from 0.75 wt % to 2.4 wt %, from 1.1 wt % to 2 wt %, or from 1.3 wt % to 1.7 wt %. In one embodiment, the bitter blocking agent is present in the taste modifier composition in an amount at least 0.15 wt %, e.g., at least 0.75 wt %, at least 1.1 wt %, or at least 1.3 wt %. In one embodiment, the bitter blocking agent is present in the taste modifier composition in an amount less than 3 wt %, e.g., less than 2.4 wt %, less than 2 wt %, or less than 1.7 wt %.

In one embodiment, if a bitter blocking agent is present in the taste modifier composition, the bitter blocking agent is present in an amount ranging from 0.1 wt % to 25 wt %, e.g., from 1 wt % to 20 wt %, from 3 wt % to 15 wt %, or from 5 wt % to 15 wt %. In one embodiment, the bitter blocking agent is present in the taste modifier composition in an amount at least 0.1 wt %, e.g., at least 1 wt %, at least 3 wt %, or at least 5 wt %. In one embodiment, the bitter blocking agent is present in the taste modifier composition in an amount less than 25 wt %, e.g., less than 20 wt %, less than 15 wt %, or less than 12 wt %.

In one embodiment, if a bitter blocking agent is present in the taste modifier composition, the bitter blocking agent is present in an amount ranging from 1 wt % to 60 wt %, e.g., from 5 wt % to 55 wt %, from 15 wt % to 45 wt %, or from 25 wt % to 35 wt %. In one embodiment, the bitter blocking agent is present in the taste modifier composition in an amount at least 1 wt %, e.g., at least 5 wt %, at least 15 wt %, or at least 25 wt %. In one embodiment, the bitter blocking agent is present in the taste modifier composition in an amount less than 60 wt %, e.g., less than 55 wt %, less than 45 wt %, or less than 35 wt %.

In one embodiment, if maltol (or a maltol derivative) is present in the taste modifier composition, the maltol is present in the taste modifier composition in an amount ranging from 0.1 wt % to 85 wt %, e.g., from 1 wt % to 75 wt %, or from 5 wt % to 65 wt %.

In one embodiment, if maltol (or a maltol derivative) is present in the taste modifier composition, the maltol is present in the taste modifier composition in an amount ranging from 0.1 wt % to 15 wt %, e.g., from 0.2 wt % to 10 wt %, from 0.5 wt % to 8 wt %, or from 1 wt % to 5 wt %. In one embodiment, the maltol is present in the taste modifier composition in an amount at least 0.1 wt %, e.g., at least 0.2 wt %, at least 0.5 wt %, or at least 1 wt %. In one embodiment, the maltol is present in the taste modifier composition in an amount less than 15 wt %, e.g., less than 10 wt %, less than 8 wt %, or less than 5 wt %.

In one embodiment, if maltol (or a maltol derivative) is present in the taste modifier composition, the maltol is present in the taste modifier composition in an amount ranging from 1 wt % to 35 wt %, e.g., from 2 wt % to 30 wt %, from 3 wt % to 25 wt %, or from 5 wt % to 22 wt %. In one embodiment, the maltol is present in the taste modifier composition in an amount at least 1 wt %, e.g., at least 2 wt %, at least 3 wt %, or at least 5 wt %. In one embodiment, the maltol is present in the taste modifier composition in an amount less than 35 wt %, e.g., less than 30 wt %, less than 25 wt %, or less than 22 wt %.

In one embodiment, if maltol (or a maltol derivative) is present in the taste modifier composition, the maltol is present in the taste modifier composition in an amount ranging from 25 wt % to 85 wt %, e.g., from 30 wt % to 70 wt %, from 35 wt % to 65 wt %, or from 35 wt % to 55 wt %. In one embodiment, the maltol is present in the taste modifier composition in an amount at least 25 wt %, e.g., at least 30 wt %, at least 35 wt %, or at least 40 wt %. In one embodiment, the maltol is present in the taste modifier composition in an amount less than 85 wt %, e.g., less than 70 wt %, less than 65 wt %, or less than 55 wt %.

In one embodiment, if a high molecular weight ester is present in the taste modifier composition, the high molecular weight ester is present in an amount ranging from 0.001 wt % to 10 wt %, e.g., from 0.005 wt % to 8 wt %, or from 0.02 wt % to 5 wt %.

In one embodiment, if a high molecular weight ester is present in the taste modifier composition, the high molecular weight ester is present in an amount ranging from 0.001 wt % to 1 wt %, e.g., from 0.005 wt % to 0.5 wt %, from 0.01 wt % to 0.2 wt %, or from 0.02 wt % to 0.07 wt %. In one embodiment, the high molecular weight ester is present in the taste modifier composition in an amount at least 0.001 wt %, e.g., at least 0.005 wt %, at least 0.01 wt %, or at least 0.02 wt %. In one embodiment, the high molecular weight ester is present in the taste modifier composition in an amount less than 1 wt %, e.g., less than 0.5 wt %, less than 0.2 wt %, or less than 0.1 wt %.

In one embodiment, if a high molecular weight ester is present in the taste modifier composition, the high molecular weight ester is present in an amount ranging from 0.01 wt % to 5 wt %, e.g., from 0.05 wt % to 3 wt %, from 0.05 wt % to 2 wt %, or from 0.1 wt % to 0.7 wt %. In one embodiment, the high molecular weight ester is present in the taste modifier composition in an amount at least 0.01 wt %, e.g., at least 0.05 wt %, at least 0.08 wt %, or at least 0.1 wt %. In one embodiment, the high molecular weight ester is present in the taste modifier composition in an amount less than 5 wt %, e.g., less than 3 wt %, less than 2 wt %, or less than 0.7 wt %.

In one embodiment, if a high molecular weight ester is present in the taste modifier composition, the high molecular weight ester is present in an amount ranging from 0.01 wt % to 10 wt %, e.g., from 0.05 wt % to 5 wt %, from 0.1 wt % to 4 wt %, or from 0.4 wt % to 1.2 wt %. In one embodiment, the high molecular weight ester is present in the taste modifier composition in an amount at least 0.01 wt %, e.g., at least 0.05 wt %, at least 0.1 wt %, or at least 0.4 wt %. In one embodiment, the high molecular weight ester is present in the taste modifier composition in an amount less than 10 wt %, e.g., less than 5 wt %, less than 4 wt %, or less than 1.2 wt %.

In one embodiment, if a carbonyl compound is present in the taste modifier composition, the carbonyl compound is present in an amount ranging from 0.0005 wt % to 10 wt %, e.g., from 0.002 wt % to 5 wt %, or from 0.005 wt % to 1 wt %.

In one embodiment, if a carbonyl compound is present in the taste modifier composition, the carbonyl compound is present in an amount ranging from 0.0005 wt % to 0.01 wt %, e.g., from 0.002 wt % to 0.009 wt %, from 0.004 wt % to 0.008 wt %, or from 0.005 wt % to 0.007 wt %. In one embodiment, the carbonyl compound is present in the taste modifier composition in an amount at least 0.0005 wt %, e.g., at least 0.002 wt %, at least 0.004 wt %, or at least 0.005 wt %. In one embodiment, the carbonyl compound is present in the taste modifier composition in an amount less than 0.01 wt %, e.g., less than 0.009 wt %, less than 0.008 wt %, or less than 0.007 wt %.

In one embodiment, if a carbonyl compound is present in the taste modifier composition, the carbonyl compound is present in an amount ranging from 0.001 wt % to 1 wt %, e.g., from 0.005 wt % to 0.5 wt %, from 0.005 wt % to 0.3 wt %, or from 0.01 wt % to 0.1 wt %. In one embodiment, the carbonyl compound is present in the taste modifier composition in an amount at least 0.001 wt %, e.g., at least 0.005 wt %, at least 0.01 wt %, or at least 0.1 wt %. In one embodiment, the carbonyl compound is present in the taste modifier composition in an amount less than 1 wt %, e.g., less than 0.5 wt %, less than 0.3 wt %, or less than 0.1 wt %.

In one embodiment, if a carbonyl compound is present in the taste modifier composition, the carbonyl compound is present in an amount ranging from 0.01 wt % to 10 wt %, e.g., from 0.02 wt % to 5 wt %, from 0.03 wt % to 1 wt %, or from 0.05 wt % to 0.15 wt %. In one embodiment, the carbonyl compound is present in the taste modifier composition in an amount at least 0.01 wt %, e.g., at least 0.02 wt %, at least 0.03 wt %, or at least 0.05 wt %. In one embodiment, the carbonyl compound is present in the taste modifier composition in an amount less than 10 wt %, e.g., less than 5 wt %, less than 1 wt %, or less than 0.15 wt %.

In one embodiment, if sodium chloride is present in the taste modifier composition, the sodium chloride is present in an amount ranging from 8 wt % to 100 wt %, e.g., from 40 wt % to 99.5 wt %, from 60 wt % to 99 wt %, or from 75 wt % to 95 wt %. In one embodiment, the sodium chloride is present in the taste modifier composition in an amount at least 8 wt %, e.g., at least 40 wt %, at least 60 wt %, or at least 75 wt %. In one embodiment, the sodium chloride is present in the taste modifier composition in an amount less than 100 wt %, e.g., less than 99.5 wt %, less than 99 wt %, or less than 95 wt %. Weight percents are based on the total weight of the taste modifier composition.

In one embodiment, if trehalose is present in the taste modifier composition, the trehalose is present in an amount ranging from 0.5 wt % to 90 wt %, e.g., from 4 wt % to 80 wt %, or from 10 wt % to 70 wt %.

In one embodiment, if trehalose is present in the taste modifier composition, the trehalose is present in an amount ranging from 0.5 wt % to 20 wt %, e.g., from 4 wt % to 15 wt %, from 5 wt % to 12 wt %, or from 7 wt % to 10 wt %. In one embodiment, the trehalose is present in the taste modifier composition in an amount at least 0.5 wt %, e.g., at least 4 wt %, at least 5 wt %, or at least 7 wt %. In one embodiment, the trehalose is present in the taste modifier composition in an amount less than 20 wt %, e.g., less than 15 wt %, less than 12 wt %, or less than 10 wt %. Weight percents are based on the total weight of the taste modifier composition.

In one embodiment, if trehalose is present in the taste modifier composition, the trehalose is present in an amount ranging from 30 wt % to 90 wt %, e.g., from 35 wt % to 85 wt %, from 45 wt % to 75 wt %, or from 50 wt % to 70 wt %. In one embodiment, the trehalose is present in the taste modifier composition in an amount at least 30 wt %, e.g., at least 35 wt %, at least 45 wt %, or at least 50 wt %. In one embodiment, the trehalose is present in the taste modifier composition in an amount less than 90 wt %, e.g., less than 85 wt %, less than 75 wt %, or less than 70 wt %. Weight percents are based on the total weight of the taste modifier composition.

In one embodiment, if dimethylanthranilate is present in the taste modifier composition, the dimethylanthranilate is present in an amount ranging from 0.007 wt % to 10 wt %, e.g., from 0.03 wt % to 5 wt %, or from 0.06 wt % to 1 wt %.

In one embodiment, if dimethylanthranilate is present in the taste modifier composition, the dimethylanthranilate is present in an amount ranging from 0.007 wt % to 0.15 wt %, e.g., from 0.03 wt % to 0.11 wt %, from 0.05 wt % to 0.09 wt %, or from 0.06 wt % to 0.08 wt %. In one embodiment, the dimethylanthranilate is present in the taste modifier composition in an amount at least 0.007 wt %, e.g., at least 0.03 wt %, at least 0.05 wt %, or at least 0.06 wt %. In one embodiment, the dimethylanthranilate is present in the taste modifier composition in an amount less than 0.15 wt %, e.g., less than 0.11 wt %, less than 0.09 wt %, or less than 0.08 wt %.

In one embodiment, if dimethylanthranilate is present in the taste modifier composition, the dimethylanthranilate is present in an amount ranging from 0.01 wt % to 5 wt %, e.g., from 0.05 wt % to 3 wt %, from 0.05 wt % to 0.2 wt %, or from 0.1 wt % to 0.8 wt %. In one embodiment, the dimethylanthranilate is present in the taste modifier composition in an amount at least 0.01 wt %, e.g., at least 0.05 wt %, at least 0.07 wt %, or at least 0.1 wt %. In one embodiment, the dimethylanthranilate is present in the taste modifier composition in an amount less than 5 wt %, e.g., less than 3 wt %, less than 2 wt %, or less than 0.8 wt %.

In one embodiment, if dimethylanthranilate is present in the taste modifier composition, the dimethylanthranilate is present in an amount ranging from 0.1 wt % to 15 wt %, e.g., from 0.5 wt % to 10 wt %, from 0.7 wt % to 3 wt %, or from 0.8 wt % to 2 wt %. In one embodiment, the dimethylanthranilate is present in the taste modifier composition in an amount at least 0.1 wt %, e.g., at least 0.5 wt %, at least 0.7 wt %, or at least 0.8 wt %. In one embodiment, the dimethylanthranilate is present in the taste modifier composition in an amount less than 15 wt %, e.g., less than 10 wt %, less than 3 wt %, or less than 2 wt %.

As disclosed herein, in cases where more than one of the respective component, e.g., plant extract or amino acid, are present, the ranges and limits relate to all individual plant extracts, combined, that may be present in the taste modifier composition. Weight percents are based on the total weight of the taste modifier composition.

In one embodiment wherein the taste modifier composition comprises the plant extract, maltol, and the bitter blocker, the plant extract may be present in the taste modifier composition in an amount ranging from 10 wt % to 99 wt %, e.g., from 20 wt % to 80 wt %, from 30 wt % to 70 wt %, or from 40 wt % to 60 wt %. In one embodiment, the plant extract is present in the taste modifier composition in an amount at least 10 wt %, e.g., at least 20 wt %, at least 30 wt %, or at least 40 wt %. In one embodiment, the plant extract is present in the taste modifier composition in an amount less than 99 wt %, e.g., less than 80 wt %, less than 70 wt %, or less than 60 wt %.

In one embodiment, the maltol may be present in the taste modifier composition in an amount ranging from 1 wt % to 50 wt %, e.g., from 5 wt % to 40 wt %, from 7 wt % to 30 wt %, or from 10 wt % to 30 wt %. In one embodiment, the maltol is present in the taste modifier composition in an amount at least 1 wt %, e.g., at least 5 wt %, at least 7 wt %, or at least 10 wt %. In one embodiment, the maltol is present in the taste modifier composition in an amount less than 50 wt %, e.g., less than 40 wt %, or less than 30 wt %.

In one embodiment, the bitter blocking agent may be present in the taste modifier composition in an amount ranging from 1 wt % to 60 wt %, e.g., from 5 wt % to 55 wt %, from 10 wt % to 50 wt %, or from 25 wt % to 40 wt %. In one embodiment, the maltol is present in the taste modifier composition in an amount at least 1 wt %, e.g., at least 5 wt %, at least 10 wt %, or at least 25 wt %. In one embodiment, the maltol is present in the taste modifier composition in an amount less than 60 wt %, e.g., less than 55 wt %, less than 50 wt %, or less than 40 wt %.

In some embodiments, the taste modifier composition may comprise components in addition to the plant extract, the bitter blocking agent, and the maltol. These additional components may include the other components discussed herein. The characteristics, weight percentages, and limits herein discussed are applicable to the taste modifier compositions comprising the plant extract, the bitter blocking agent, and the maltol.

In some embodiments, the taste modifier composition comprises the various components discussed herein. The ranges and limits for the one individual component may be used in combination with the respective ranges and limits for other components. For example, the taste modifier composition may comprise the plant extract present in the taste modifier composition in an amount ranging from 0.09 wt % to 2 wt %, e.g., from 0.4 wt % to 1.5 wt %, from 0.7 wt % to 1.2 wt %, or from 0.8 wt % to 1.1 wt %; the amino acid present in the taste modifier composition in an amount ranging from 0.008 wt % to 0.2 wt %, e.g., from 0.04 wt % to 0.14 wt %, from 0.06 wt % to 0.12 wt %, or from 0.07 wt % to 0.1 wt %; and the lactone present in the taste modifier composition in an amount ranging from 0.006 wt % to 0.12 wt %, e.g., from 0.03 wt % to 0.1 wt %, from 0.04 wt % to 0.08 wt %, or from 0.05 wt % to 0.07 wt %.

As another example, the plant extract present in the taste modifier composition in an amount ranging from 0.1 wt % to 15 wt %, e.g., from 0.5 wt % to 10 wt %, or from 2 wt % to 10 wt %; the amino acid present in the taste modifier composition in an amount ranging from 0.01 wt % to 10 wt %, e.g., from 0.05 wt % to 7 wt %, from 0.1 wt % to 3 wt %, or from 0.2 wt % to 1 wt %; and the lactone present in the taste modifier composition in an amount ranging from 0.01 wt % to 10 wt %, e.g., from 0.05 wt % to 7 wt %, from 0.1 wt % to 3 wt %, or from 0.2 wt % to 0.9 wt %.

As another example, the plant extract present in the taste modifier composition in an amount ranging from 1 wt % to 50 wt %, e.g., from 5 wt % to 40 wt %, or from 10 wt % to 30 wt %; the amino acid present in the taste modifier composition in an amount ranging from 0.1 wt % to 20 wt %, e.g., from 0.2 wt % to 10 wt %, from 0.3 wt % to 5 wt %, or from 1 wt % to 2 wt %; and the lactone present in the taste modifier composition in an amount ranging from 0.1 wt % to 20 wt %, e.g., from 0.2 wt % to 10 wt %, from 0.3 wt % to 5 wt %, or from 0.5 wt % to 1.6 wt %. Other combinations of the components and the respective ranges and limits are contemplated and these examples are not meant to limit the potential combinations.

In some embodiments, the taste modifier compositions comprise at least one additional substance. For example, the at least one additional substance(s) may be selected from the group consisting of tannic acid, decanoic acid, propanoic acid, phenylethylacetate, phenylethylalcohol, cinnamic alcohol, boronia absolute, guaicwood, e.g., guiacwood oil, onone, e.g., alpha onone and/or beta onone, damascenone, e.g., beta damascenone, indole, and combinations thereof. Preferably, at least one of these additional substances is of natural origin. In one embodiment, all of these additional substances are of natural origin. In one embodiment, at least one of these additional substances is of artificial origin, e.g., synthesized. These additional substances are commercially available. Other additional substances are discussed below.

Tables 1a-c show exemplary individual weight percentage ranges and limits components for several potential components of the taste modifier composition. The limits in the table may be combined to form the respective range.

TABLE 1a
Exemplary Component Weight Percentage Limits and Ranges
in the Taste Modifier Composition

| Component | Low 1 | High 1 | Low 2 | High 2 | Low 3 | High 3 | Low 4 | High 4 |
|---|---|---|---|---|---|---|---|---|
| Trehalose | 0.86% | 16.39% | 4.31% | 12.94% | 6.47% | 10.78% | 7.76% | 9.49% |
| Sodium | 8.63% | 99% | 43.13% | 99% | 64.70% | 99% | 77.64% | 94.89% |
| Chloride | | | | | | | | |
| Benzoin (abs.) | 0.09% | 1.64% | 0.43% | 1.29% | 0.65% | 1.08% | 0.78% | 0.95% |
| Maltol | 0.23% | 4.43% | 1.16% | 3.49% | 1.75% | 2.91% | 2.10% | 2.56% |
| Naringin | 0.16% | 2.95% | 0.78% | 2.33% | 1.16% | 1.94% | 1.40% | 1.71% |
| d- | 0.0044% | 0.0836% | 0.0220% | 0.0660% | 0.0330% | 0.0550% | 0.0396% | 0.0484% |
| Dodecalactone | | | | | | | | |
| Massoialactone | 0.0011% | 0.0213% | 0.0056% | 0.0168% | 0.0084% | 0.0140% | 0.0101% | 0.0123% |
| d-decalactone | 0.0006% | 0.0105% | 0.0028% | 0.0083% | 0.0041% | 0.0069% | 0.0050% | 0.0061% |
| Valine | 0.0002% | 0.0044% | 0.0012% | 0.0035% | 0.0017% | 0.0029% | 0.0021% | 0.0026% |
| Acetoin | 0.0002% | 0.0038% | 0.0010% | 0.0030% | 0.0015% | 0.0025% | 0.0018% | 0.0022% |
| Pimento berry | 0.000006% | 0.000115% | 0.000030% | 0.000091% | 0.000045% | 0.000075% | 0.000054% | 0.000066% |
| oil | | | | | | | | |
| Ethylpalmitate | 0.00063% | 0.01196% | 0.00315% | 0.00945% | 0.00472% | 0.00787% | 0.00567% | 0.00693% |
| Sandalwood oil | 0.000006% | 0.000115% | 0.000030% | 0.000091% | 0.000045% | 0.000075% | 0.000054% | 0.000066% |
| Balsam extract | 0.000006% | 0.000115% | 0.000030% | 0.000091% | 0.000045% | 0.000075% | 0.000054% | 0.000066% |
| Proline | 0.00031% | 0.00590% | 0.00155% | 0.00466% | 0.00233% | 0.00388% | 0.00279% | 0.00342% |
| Leucine | 0.00061% | 0.01164% | 0.00306% | 0.00919% | 0.00459% | 0.00766% | 0.00551% | 0.00674% |
| Serine | 0.0020% | 0.0377% | 0.0099% | 0.0298% | 0.0149% | 0.0248% | 0.0179% | 0.0218% |
| Tyrosine | 0.0018% | 0.0344% | 0.0091% | 0.0272% | 0.0136% | 0.0226% | 0.0163% | 0.0199% |
| Glutamic acid | 0.0039% | 0.0738% | 0.0194% | 0.0582% | 0.0291% | 0.0485% | 0.0349% | 0.0427% |
| 2,3-pentadione | 0.00038% | 0.00721% | 0.00190% | 0.00569% | 0.00285% | 0.00474% | 0.00342% | 0.00418% |
| Caraway oil | 0.0038% | 0.0721% | 0.0190% | 0.0569% | 0.0285% | 0.0474% | 0.0342% | 0.0418% |
| Cassia oil | 0.0038% | 0.0721% | 0.0190% | 0.0569% | 0.0285% | 0.0474% | 0.0342% | 0.0418% |
| Dimethyl- | 0.0072% | 0.1360% | 0.0358% | 0.1074% | 0.0537% | 0.0895% | 0.0644% | 0.0788% |
| anthranilate | | | | | | | | |
| Ethyllaurate | 0.0038% | 0.0721% | 0.0190% | 0.0569% | 0.0285% | 0.0474% | 0.0342% | 0.0418% |
| Ginger oil | 0.0019% | 0.0361% | 0.0095% | 0.0285% | 0.0142% | 0.0237% | 0.0171% | 0.0209% |
| Sinensal | 0.000009% | 0.000164% | 0.000043% | 0.000129% | 0.000065% | 0.000108% | 0.000078% | 0.000095% |

TABLE 1b
Exemplary Component Weight Percentage Limits and Ranges
in the Taste Modifier Composition

| Component | Low 1 | High 1 | Low 2 | High 2 | Low 3 | High 3 | Low 4 | High 4 |
|---|---|---|---|---|---|---|---|---|
| Trehalose | 6.28% | 99% | 31.40% | 94.20% | 47.10% | 78.50% | 56.52% | 69.08% |
| Benzoin (abs.) | 0.63% | 11.93% | 3.14% | 9.42% | 4.71% | 7.85% | 5.65% | 6.91% |
| Maltol | 1.70% | 32.22% | 8.48% | 25.43% | 12.72% | 21.19% | 15.26% | 18.65% |
| Naringin | 1.13% | 21.48% | 5.65% | 16.96% | 8.48% | 14.13% | 10.17% | 12.43% |
| d- | 0.0320% | 0.6085% | 0.1601% | 0.4804% | 0.2402% | 0.4003% | 0.2882% | 0.3523% |
| Dodecalactone | | | | | | | | |
| Massoialactone | 0.0082% | 0.1551% | 0.0408% | 0.1225% | 0.0612% | 0.1020% | 0.0735% | 0.0898% |
| d-decalactone | 0.0040% | 0.0764% | 0.0201% | 0.0603% | 0.0301% | 0.0502% | 0.0362% | 0.0442% |
| Valine | 0.0017% | 0.0322% | 0.0085% | 0.0254% | 0.0127% | 0.0212% | 0.0153% | 0.0187% |
| Acetoin | 0.0014% | 0.0274% | 0.0072% | 0.0217% | 0.0108% | 0.0181% | 0.0130% | 0.0159% |
| Pimento berry | 0.000044% | 0.000835% | 0.000220% | 0.000659% | 0.000330% | 0.000549% | 0.000396% | 0.000484% |
| oil | | | | | | | | |
| Ethylpalmitate | 0.00458% | 0.08710% | 0.02292% | 0.06876% | 0.03438% | 0.05730% | 0.04126% | 0.05043% |
| Sandalwood oil | 0.000044% | 0.000835% | 0.000220% | 0.000659% | 0.000330% | 0.000549% | 0.000396% | 0.000484% |
| Balsam extract | 0.000044% | 0.000835% | 0.000220% | 0.000659% | 0.000330% | 0.000549% | 0.000396% | 0.000484% |
| Proline | 0.00226% | 0.04295% | 0.01130% | 0.03391% | 0.01696% | 0.02826% | 0.02035% | 0.02487% |
| Leucine | 0.00446% | 0.08471% | 0.02229% | 0.06688% | 0.03344% | 0.05573% | 0.04013% | 0.04905% |
| Serine | 0.0144% | 0.2744% | 0.0722% | 0.2167% | 0.1083% | 0.1805% | 0.1300% | 0.1589% |
| Tyrosine | 0.0132% | 0.2506% | 0.0659% | 0.1978% | 0.0989% | 0.1648% | 0.1187% | 0.1451% |
| Glutamic acid | 0.0283% | 0.5369% | 0.1413% | 0.4239% | 0.2119% | 0.3532% | 0.2543% | 0.3108% |
| 2,3-pentadione | 0.00276% | 0.05250% | 0.01382% | 0.04145% | 0.02072% | 0.03454% | 0.02487% | 0.03039% |
| Caraway oil | 0.0276% | 0.5250% | 0.1382% | 0.4145% | 0.2072% | 0.3454% | 0.2487% | 0.3039% |
| Cassia oil | 0.0276% | 0.5250% | 0.1382% | 0.4145% | 0.2072% | 0.3454% | 0.2487% | 0.3039% |
| Dimethyl- | 0.0521% | 0.9903% | 0.2606% | 0.7818% | 0.3909% | 0.6515% | 0.4691% | 0.5733% |
| anthranilate | | | | | | | | |
| Ethyllaurate | 0.0276% | 0.5250% | 0.1382% | 0.4145% | 0.2072% | 0.3454% | 0.2487% | 0.3039% |
| Ginger oil | 0.0138% | 0.2625% | 0.0691% | 0.2072% | 0.1036% | 0.1727% | 0.1243% | 0.1520% |
| Sinensal | 0.000063% | 0.001193% | 0.000314% | 0.000942% | 0.000471% | 0.000785% | 0.000565% | 0.000691% |

TABLE 1c
Exemplary Component Weight Percentage Limits and Ranges
in the Taste Modifier Composition

| Component | Low 1 | High 1 | Low 2 | High 2 | Low 3 | High 3 | Low 4 | High 4 |
|---|---|---|---|---|---|---|---|---|
| Benzoin (abs.) | 1.69% | 32.07% | 8.44% | 25.32% | 12.66% | 21.10% | 15.19% | 18.57% |
| Maltol | 4.56% | 86.60% | 22.79% | 68.36% | 34.18% | 56.97% | 41.02% | 50.13% |
| Naringin | 3.04% | 57.73% | 15.19% | 45.58% | 22.79% | 37.98% | 27.35% | 33.42% |
| d- | 0.0861% | 1.6357% | 0.4304% | 1.2913% | 0.6457% | 1.0761% | 0.7748% | 0.9470% |
| Dodecalactone | | | | | | | | |
| Massoialactone | 0.0219% | 0.4169% | 0.1097% | 0.3292% | 0.1646% | 0.2743% | 0.1975% | 0.2414% |
| d-decalactone | 0.0108% | 0.2053% | 0.0540% | 0.1620% | 0.0810% | 0.1350% | 0.0972% | 0.1188% |
| Valine | 0.0046% | 0.0866% | 0.0228% | 0.0684% | 0.0342% | 0.0570% | 0.0410% | 0.0501% |
| Acetoin | 0.0039% | 0.0738% | 0.0194% | 0.0582% | 0.0291% | 0.0485% | 0.0349% | 0.0427% |
| Pimento berry | 0.000118% | 0.002245% | 0.000591% | 0.001772% | 0.000886% | 0.001477% | 0.001063% | 0.001300% |
| oil | | | | | | | | |
| Ethylpalmitate | 0.01232% | 0.23413% | 0.06161% | 0.18484% | 0.09242% | 0.15403% | 0.11090% | 0.13555% |
| Sandalwood oil | 0.000118% | 0.002245% | 0.000591% | 0.001772% | 0.000886% | 0.001477% | 0.001063% | 0.001300% |
| Balsam extract | 0.000118% | 0.002245% | 0.000591% | 0.001772% | 0.000886% | 0.001477% | 0.001063% | 0.001300% |
| Proline | 0.00608% | 0.11546% | 0.03038% | 0.09115% | 0.04558% | 0.07596% | 0.05469% | 0.06685% |
| Leucine | 0.01198% | 0.22771% | 0.05992% | 0.17977% | 0.08989% | 0.14981% | 0.10786% | 0.13183% |
| Serine | 0.0388% | 0.7377% | 0.1941% | 0.5824% | 0.2912% | 0.4853% | 0.3494% | 0.4271% |
| Tyrosine | 0.0354% | 0.6735% | 0.1772% | 0.5317% | 0.2659% | 0.4431% | 0.3190% | 0.3899% |
| Glutamic acid | 0.0760% | 1.4433% | 0.3798% | 1.1394% | 0.5697% | 0.9495% | 0.6836% | 0.8356% |
| 2,3-pentadione | 0.00743% | 0.14112% | 0.03714% | 0.11141% | 0.05570% | 0.09284% | 0.06685% | 0.08170% |
| Caraway oil | 0.0743% | 1.4112% | 0.3714% | 1.1141% | 0.5570% | 0.9284% | 0.6685% | 0.8170% |
| Cassia oil | 0.0743% | 1.4112% | 0.3714% | 1.1141% | 0.5570% | 0.9284% | 0.6685% | 0.8170% |
| Dimethyl- | 0.1401% | 2.6620% | 0.7005% | 2.1016% | 1.0508% | 1.7513% | 1.2609% | 1.5412% |
| anthranilate | | | | | | | | |
| Ethyllaurate | 0.0743% | 1.4112% | 0.3714% | 1.1141% | 0.5570% | 0.9284% | 0.6685% | 0.8170% |
| Ginger oil | 0.0371% | 0.7056% | 0.1857% | 0.5570% | 0.2785% | 0.4642% | 0.3342% | 0.4085% |
| Sinensal | 0.000169% | 0.003207% | 0.000844% | 0.002532% | 0.001266% | 0.002110% | 0.001519% | 0.001857% |

The aforementioned component ranges and limits are applicable to the inventive taste modifier compositions. The aforementioned component ranges and limits for the respective components may be used in multiple embodiments of the taste modifier compositions of the invention.

In one embodiment, the weight ratio of plant extract to amino acid ranges from 0.0001 to 1000, e.g., from 0.01 to 100, from 0.1 to 100, from 0.5 to 75, from 1 to 50, from 1 to 20, or from 2 to 15. In terms of lower limits, the weight ratio of plant extract to amino acid may be at least 0.0001, e.g., at least 0.01, at least 0.1, at least 0.5, at least 1, or at least 2. In terms of upper limits, the weight ratio of plant extract to amino acid may be less than 1000, e.g., less than 100, less than 75, less than 50, less than 20, or less than 15.

In one embodiment, the weight ratio of plant extract to lactone ranges from 0.0001 to 1000, e.g., from 0.01 to 100, from 0.1 to 100, from 0.5 to 75, from 1 to 50, from 1 to 30, or from 2 to 20. In terms of lower limits, the weight ratio of plant extract to lactone may be at least 0.0001, e.g., at least 0.01, at least 0.1, at least 0.5, at least 1, or at least 2. In terms of upper limits, the weight ratio of plant extract to lactone may be less than 1000, e.g., less than 100, less than 75, less than 50, less than 30, or less than 20.

In one embodiment, the weight ratio of amino acid to lactone ranges from 0.005 to 100, e.g., from 0.01 to 100, from 0.05 to 50, from 0.1 to 50, from 0.1 to 20, from 0.1 to 10, or from 0.5 to 5. In terms of lower limits, the weight ratio of amino acid to lactone may be at least 0.01, e.g., at least 0.05, at least 0.1, or at least 0.5. In terms of upper limits, the weight ratio of amino acid to lactone may be less than 100, e.g., less than 50, less than 20, less than 10, or less than 5.

In one embodiment, at least one of the components of the taste modifier composition, e.g., at least two, at least three, at least five, at least ten, at least fifteen, at least twenty, or at least twenty-five, is a “natural” version of the component, e.g., the component is not derived from synthesis and is of natural origin. In a preferred embodiment, all components of the taste modifier composition are natural versions.

In one embodiment, the composition further comprises at least one additional substance. The additional substance(s) may be selected from other amino acids and flavoring ingredients, and combinations thereof.

As used herein, the term “salt(s)” as it relates to the amino acids means the physiologically acceptable acid addition salts and base salts of the amino acids. Suitable acid addition salts are formed from acids which form non-toxic salts. Examples include but are not limited to the acetate, aspartate, benzoate, besylate, bicarbonate, carbonate, bisulphate, sulphate, borate, camsylate, citrate, edisylate, esylate, formate, fumarate, gluceptate, gluconate, glucuronate, hexafluorophosphate, hibenzate, hydrochloride/chloride, hydrobromide, bromide, hydroiodide, iodide, isethionate, lactate, malate, maleate, malonate, mesylate, methylsulphate, naphthylate, nicotinate, nitrate, orotate, oxalate, palmitate, pamoate, phosphate, hydrogen phosphate, dihydrogen phosphate, sacharate, stearate, succinate, tartrate, tosylate and trifluoroacetate salts. Suitable base salts are formed from bases which form non-toxic salts. Examples include but are not limited to the aluminium, arginine, benzathine, calcium, choline, diethylamine, diolamine, glycine, lysine, magnesium, meglumine, olamine, potassium, sodium, tromethamine and zinc salts.

As used herein, the term “hydrate(s)” as it relates to amino acids means an amino acid that includes water. “Hydrate(s)” are formed by the addition of water or its elements. In one embodiment, an amino acid may form crystals that incorporate water into the crystalline structure without chemical alteration.

As used herein, the term “flavoring ingredients” may include those flavor ingredients known in the art, such as natural and artificial flavors. These flavoring ingredients may be chosen from synthetic flavor oils and flavoring ingredient aromatics and/or oils, oleoresins and extracts derived from plants, leaves, flowers, fruits, and so forth, and combinations thereof. Nonlimiting representative flavor oils include spearmint oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, and oil of bitter almonds. Also useful flavoring ingredients are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavors include a milk flavor, a butter flavor, a cheese flavor, a cream flavor, and a yogurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring ingredients may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with cooling agents.

Other useful flavoring ingredients include aldehydes and esters such as cinnamyl acetate, cinnamaldehyde, citral diethylacetal, dihydrocarvyl acetate, eugenyl formate, p-methylamisol, and so forth may be used. Generally any flavoring ingredient or food additive such as those described in Chemicals Used in Food Processing, publication 1274, pages 63-258, by the National Academy of Sciences, may be used. This publication is incorporated herein by reference.

Further examples of aldehyde flavoring ingredients include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof. These listings of flavoring ingredients are merely exemplary and are not meant to limit either the term “flavoring ingredient” or the scope of the invention generally. The above-identified flavoring ingredients are known in the art and are commercially available.

In some embodiments, the flavoring ingredient may be employed in either liquid form and/or dried form. When employed in the latter form, suitable drying means such as spray drying the oil may be used. Alternatively, the flavoring ingredient may be absorbed onto water soluble materials, such as cellulose, starch, sugar, maltodextrin, gum arabic and so forth or may be encapsulated. The actual techniques for preparing such dried forms are well-known.

In some embodiments, the flavoring ingredients may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

In some embodiments, the flavoring ingredients may be used in many distinct physical forms well-known in the art to provide an initial burst of flavor and/or a prolonged sensation of flavor. Without being limited thereto, such physical forms include free forms, such as spray dried, powdered, beaded forms, encapsulated forms, and mixtures thereof.

### Methods of Making the Compositions

The invention, in another embodiment, relates to a process for the preparation of the taste modifier composition comprising admixing the various components to yield the taste modifier compositions. The invention may also relate to the preparation of the sweetener/sweetness enhancer composition comprising admixing a stevia-based sweetener and the balsamic compound (and optionally other components of the taste modifier composition) to yield the sweetener/sweetness enhancer composition.

### Sweetener/Sweetness Enhancer Compositions

It has now been found that sweetener/sweetness enhancer compositions comprising the taste modifier compositions are useful in 1) reducing the quantity of standard sugar such as sucrose that may be present in a consumable product; and/or in 2) replacing standard sugar such as sucrose that may be present in a consumable product.

The taste modifier composition comprises the balsamic compound and, optionally, one or more of the other (taste modifier) component described above and/or herein. As noted above, the sweetener/sweetness enhancer composition comprises a stevia-based sweetener, which may act as a sweetener and the balsamic compound (either alone or as a component of the taste modifier composition). In addition to a stevia-based sweetener, the sweetener/sweetness enhancer composition may comprise additional sweeteners and/or sweetness enhancers. Some additional sweeteners and sweetness enhancers (other than stevia-based sweeteners) are listed below.

Exemplary artificial or natural sweeteners include but are not limited to abiziasaponin, abrusosides, in particular abrusoside A, abrusoside B, abrusoside C, abrusoside D, acesulfame potassium, advantame, albiziasaponin, alitame, aspartame, superaspartame, bayunosides, in particular bayunoside 1, bayunoside 2, brazzein, bryoside, bryonoside, bryonodulcoside, carnosifloside, carrelame, curculin, cyanin, chlorogenic acid, cyclamates and its salts, cyclocaryoside I, dihydroquercetin-3-acetate, dihydroflavenol, dulcoside, gaudichaudioside, glycyrrhizin, glycyrrhetin acid, gypenoside, hematoxylin, hernandulcin, isomogrosides, in particular iso-mogroside V, lugduname, magap, mabinlins, micraculin, mogrosides (lo han guo), in particular mogroside IV and mogroside V, monatin and its derivatives, monellin, mukurozioside, naringin dihydrochalcone (NarDHC), neohesperidin dihydrochalcone (NDHC), neotame, osladin, pentadin, periandrin I-V, perillartine, D-phenylalanine, phlomisosides, in particular phlomisoside 1, phlomisoside 2, phlomisoside 3, phlomisoside 4, phloridzin, phyllodulcin, polpodiosides, polypodoside A, pterocaryosides, saccharin and its salts and derivatives, scandenoside, selligueanin A, siamenosides, in particular siamenoside I, suaviosides A, B and G-J, strogines, in particular strogin 1, strogin 2, strogin 4, suavioside A, suavioside B, suavioside G, suavioside H, suavioside I, suavioside J, sucronate, sucrooctate, talin, telosmoside A₁₅, thautamin, in particular thautamin I and II, trans-anethol, trans-cinnamaldehyde, trilobatin and D-tryptophane, including extracts or enriched fractions of the natural sweeteners.

Additional exemplary artificial or natural sweeteners include sugar alcohols (or polyols), which include, but are not limited to erythritol, galactitol, hydrogenated starch syrups including maltitol and sorbitol syrups, inositols, isomalt, lactitol, maltitol, mannitol, xylitol, and combinations thereof. Sugar sweeteners (or carbohydrates) are also exemplary and include monosaccharides, disaccharides, oligosaccharides and polysaccharides such as but not limited to arabinose, dextrin, dextrose, fructose, high fructose corn syrup, fructooligosaccharides, fructooligosaccharide syrups, galactose, galactooligosaccharides, glucose, glucose and (hydrogenated) starch syrups/hydrolysates, isomaltulose, lactose, hydrolysed lactose, maltose, mannose, rhamnose, ribose, sucrose, stachyose, tagatose, trehalose, xylose, and combinations thereof. The sweeteners are known substances and are for example those described by H. Mitchell (H. Mitchell, “Sweeteners and Sugar Alternatives in Food Technology”, Backwell Publishing Ltd, 2006) and in WO 2009/023975 A2, each of which is incorporated herein by reference in its entirety. Sweeteners may also include hydrogenated starch hydrolysates such as those disclosed in U.S. Pat. No. 4,279,931, which is hereby incorporated by reference, and various hydrogenated glucose syrups and/or powders which contain sorbitol, maltitol, hydrogenated disaccharides, hydrogenated higher polysaccharides, or combination thereof. Hydrogenated starch hydrosylates are primarily prepared by the controlled catalytic hydrogenation of con syrups. The resulting hydrogenated starch hydrosylates are mixtures of monomeric, dimeric, and polymeric saccharides. The hydrogenated starch hydrolysates are known in the art and are commercially available. The above-identified sweeteners are known in the art and are commercially available.

The additional sweetener, if employed, may be selected from the group consisting of extracts and corresponding enriched fractions of: Thaumatococcus extracts (sweet prayers plant), extracts of Stevia ssp. (in particular Stevia rebaudiana), swingle extract (Mormordica or Siratia grosvenorii, Luo-Han-Guo), extracts of Glycerryzia ssp. (in particular Glycerhyzia glabra), extracts of Rubus ssp. (in particular Rubus suavissimus), citrus extracts, extracts of Lippia dulcis, Buddha tea extracts (Hydrangea dulcis and other phyllodulcin-containing Hydrangea ssp.).

The additional sweetener, if employed, may be a caloric sweetener and/or a non-caloric sweetener.

Preferably, the optional additional sweetener comprises acesulfame-K, aspartame, neotame, thautamin, and combinations thereof.

In one embodiment, the sweetener/sweetness enhancer compositions further comprise at least one sweetness enhancer, e.g., at least two or at least three, in addition to the stevia-based sweetener and the balsamic compound. Suitable sweetness enhancers are well known in the art. It is noted that some compounds may be considered both a sweetener and a sweetness enhancer and vice versa.

As used herein, the term “sweetness enhancer(s)” means any compound capable of enhancing or intensifying the perception of sweet taste of sweetener compositions or sweetened compositions. The term “sweetness enhancer” is synonymous to the terms “sweet taste potentiator,” “sweetness potentiator,” and “sweetness intensifier”.

In one embodiment, the at least one sweetness enhancer, if employed, may be selected from the group consisting of terpenes (such as sesquiterpenes, diterpenes, and triterpenes), flavonoids, amino acids, proteins, polyols, other known natural sweeteners (such as cinnamaldehydes, selligueains and hematoxylins), secodammarane glycosides, and analogues thereof.

Exemplary sweetness enhancers include dulcoside A, rubusoside; hernandulcin; pine rosin diperpenoid; mukurozioside; baiyunosdie; phlomisoside, such as phlomisoside I and phlomisodie II; glycyrrhizic acid; periandrins, such as periandrin I, periandrin II, periandrin III, and periandrin IV; osladin; polypodosides, such as polypodoside A and polypodoside B; mogrosides, such as mogroside IV and mogroside V; abrusoside A and abrusosdie B; cyclocariosdies, such as cyclocarioside A and cyclocarioside B; pterocaryoside A and pterocaryoside B; flavonoids, such as phyllodulcin, phloridzin, neoastilbin, and dihydroquercetin acetate; amino acids, such as glycine and monatin; proteins, such as thautamins (thautamin I, thautamin II, thautamin iii, and thautamin IV), monellin, mabinlins (mabinlin I and mabinlin II), brazzein, miraculin, and curculin; polyols such as erythritol; cinnamaldehyde; selligueains, such as selligueain A and selligueain B; hematoxylin; and mixtures thereof.

Additional exemplary sweetness enhancers include pine rosin diterpenoids; phloridizin; neoastilbin; dihydroquercetin acetate; glycine; erythritol; cinnamaldehyde; selligueain A; selligueain B; hematoxylin; dulcoside A; mogroside V; Luo Han Guo; siamenoside; siamenoside I; monatin and salts thereof (monatin SS, RR, RS, SR); curculin; glycyrrhizic acid and its salts; thautamin I; thautamin II; thautamin III; thautamin IV; monellin; mabinlin I; mabinlin II; brazzein; hernandulcin; phyllodulcin; glycyphyllin; phloridzin; trilobatin; baiyunoside; osladin; polypodoside A; polypodoside B; pterocaryoside A; pterocaryoside B; mukurozioside; mukurozioside lib; phlomisoside I; phlomisoside II; periandrin I; periandrin II; periandrin III; periandrin VI; periandrin V; cyclocarioside A; cyclocarioside B; suavioside A; suavioside B; suavioside G; suavioside H; suavioside I; suavioside J; labdane glycosides; baiyunoside; gaudichaudioside A; mogroside IV; iso-mogroside; bryodulcoside; bryobioside; bryoside; bryonoside; carnosifloside V; carnosifloside VI; scandenoside R6; 1 1-oxomogroside V; abrusoside A; abrusoside B; abrusoside C; abrusoside D; abrusoside E; gypenoside XX; glycyrrhizin; apioglycyrrhizin; araboglycyrrhizin; pentadin; perillaldehyde; rebaudioside F; steviol; 13-[(2-O-(3-O-α-D-glucopyranosyl)-β-D-glucopyranosyl-3-O-β-D-glucopyranosyl-β-D-glucopyranosyl)oxy]kaur-16-en-18-oic acid β-D-glucopyranosyl ester; 13-[(2-O-β-D-glucopyranosyl-3-O-(4-O-α-D-glucopyranosyl)-β-D-glucopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-hydroxy-kaur-16-en-18-oic acid β-D-glucopyranosyl ester; 13-methyl-16-oxo-17-norkauran-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-glucopyranosyl-β-D-glucopyranosyl)oxy]kaur-15-en-18-oic acid; 13-[(2-O-β-D-glucopyranosyl-3-O-β-D-glucopyranosyl-β-D-glucopyranosyl)oxy]-17-hydroxy-kaur-15-en-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid β-D-glucopyranosyl ester; 13-[(2-O-β-D-glucopyranosyl-3-O-β-D-glucopyranosyl-β-D-glucopyranosyl)oxy]-16-hydroxy kauran-18-oic acid; isosteviol; mogroside IA; mogroside IE; mogroside II-A; mogroside II-E; mogroside III; mogroside V; isomogroside V; 1 1-Oxomogroside; mogrol; 1 1-oxomogrol; 1 1-oxomogroside IA; 1-[13-hydroxykaur-16-en-18-oate](3-D-glucopyranuronic acid; 13-[(2-O-β-D-glucopyranosyl(3-D-glucopyranosyl)oxyl-17-hydroxy-kaur-15-en-18-oic acid β-D-glucopyranosyl ester; 13-[(2-0-β-D-glucopyranosyl-β-D-glucopyranosyl)oxy]kaur-16-en-18-oic acid-(2-O-β-D-glucopyranosyl-β-D-glucopyranosyl]ester (rebaudioside E); 13-[(2-O-α-L-rhamnopyranosyl-3-O-β-D-glucopyranosyl-β-D-glucopyranosyl)oxy]kaur-16-en-18-oic acid-(2-O-β-D-glucopyranosyl-β-D-glucopyranosyl)ester; 13-[(2-O-β-D-glucopyranosyl-3-O-β-D-glucopyranosyl-β-D-glucopyranosyl)oxy]-kaur-16-en-18-oic acid-(2-O-α-L-rhamnopyranosyl-β-D-glucopyranosyl)ester; 13-[(2-O-β-D-glucopyranosyl β-D-glucopyranosyl)oxy]-17-oxo-kaur-15-en-oic acid β-D-glucopyranosl ester; 13-[(2-O-(6-O-β-D-glucopyranosyl)-β-D-glucopyranosyl-β-D-glucopyranosyl)oxy]kaur-16-en-18-oic acid β-D-glucopyranosyl ester; 13-[(2-O-β-D-glucopyranosyl-3-O-β-D-fructofuranosyl-β-D-glucopyranosyl)oxy]kaur-16-en-18-oic acid β-D-glucopyranosyl ester; 13-[(2O-β-D-glucopyranosyl-β-D-glucopyranosyl)oxy]kaur-16-en-18-oic acid-(6-O-β-D-xylopyranosyl-β-D-glucopyranosyl)ester; 13-[(2-O-β-D-glucopyranosyl-β-D-glucopyranosyl)oxy]kaur-16-en-18-oic acid-(4-O-(2-O-α-D-glucopyranosyl)-α-D-glucopyranosyl-D-glucopyranosyl) ester; 13-[(2-O-β-D-glucopyranosyl-3-O-β-D-glucopyranosyl-β-D-glucopyranosyl)oxy]kaur-16-en-18-oic acid-(2-O-6-deoxy-β-D-glucopyranosyl-β-D-glucopyranosyl)ester; 13-[(2-O-β-D-glucopyranosyl-β-D-glucopyranosyl)oxy]kaur-15-en-18-oic acid β-D-glucopyranosyl ester; 13-[(2-O-β-D-glucopyranosyl-3-O-β-D-xylopyranosyl-β-D-glucopyranosyl)oxy]kaur-16-en-18-oic acid β-D-glucopyranosyl ester; 13-[(2-O-β-D-xylopyranosyl-β-D-glucopyranosyl)oxy]kaur-16-en-18-oic acid β-D-glucopyranosyl ester; 13-[(3-O-β-D-glucopyranosyl-β-D-glucopyranosyl)oxy]kaur-16-en-18-oic acid β-D-glucopyranosyl ester; 13-[(2-O-6-deoxy-β-D-glucopyranosyl-3-O-β-D-glucopyranosyl-β-D-glucopyranosyl)oxy]kaur-16-en-18-oic acid β-D-glucopyranosyl ester; 13-[(2-O-6-deoxy β-D-glucopyranosyl-β-D-glucopyranosyl)oxy]kaur-16-en-18-oic acid β-D-glucopyranosyl ester; and mixtures thereof.

Additional exemplary sweetness enhancers include 13-[(2-O-β-D-glucopyranosyl-3-O-β-D-glucopyranosyl]-β-D-glucopyranosyl)oxyl-17-hydroxy-kaur-15-en-18-oic acid β-D-glucopyranosyl ester, 13-[(2-O-(3-O-β-D-glucopyranosyl)-β-D-glucopyranosyl-3-O-β-D-glucopyranosyl-β-D-glucopyranosyl)oxy]kaur-16-en-18-oic acid β-D-glucopyranosyl ester. Further for example, the at least one sweetness enhancer is chosen from mogroside V, mogroside IV, brazzein, and monatin.

When employed in a sweetener composition or in a sweetness enhancer composition, the taste modifier composition may be present in accordance with the following ranges and limits, which are based on the total weight of the sweetener composition or the sweetness enhancer composition, respectively. These ranges and limits are exemplary and are not meant to be limiting.

In one embodiment, the taste modifier composition is present in the sweetener/sweetness enhancer composition in an amount ranging from 0.05 wt % to 30 wt %, e.g., from 0.1 wt % to 20 wt %, from 0.1 wt % to 10 wt %, from 1 wt % to 20 wt %, from 0.5 wt % to 15 wt %, from 1 wt % to 10 wt %, from 5 wt % to 20 wt %, or from 3 wt % to 15 wt %. In terms of lower limits, the taste modifier composition is present in the sweetener/sweetness enhancer composition in an amount at least 0.05 wt %, e.g., at least 0.1 wt %, at least 0.5 wt %, at least 1 wt % at least 3 wt %, or at least 5 wt %. In terms of upper limits, the taste modifier composition is present in the sweetener/sweetness enhancer composition in an amount less than 30 wt %, e.g., less than 20 wt %, less than 15 wt %, less than 10 wt %, less than 8 wt % or less than 3 wt %.

In one embodiment, the taste modifier composition is present in the sweetener/sweetness enhancer composition in an amount ranging from 0.5 wt % to 15 wt %, e.g., from 1 wt % to 11 wt % or from 2 wt % to 9 wt %. In terms of lower limits, the taste modifier composition is present in the sweetener/sweetness enhancer composition in an amount at least 0.5 wt %, e.g., at least 1 wt % or at least 2 wt %. In terms of upper limits, the taste modifier composition is present in the sweetener/sweetness enhancer composition in an amount less than 15 wt %, e.g., less than 11 wt % or less than 9 wt %.

In one embodiment, the taste modifier composition is present in the sweetener/sweetness enhancer composition in an amount ranging from 10 wt % to 55 wt %, e.g., from 20 wt % to 45 wt % or from 25 wt % to 35 wt %. In terms of lower limits, the taste modifier composition is present in the sweetener/sweetness enhancer composition in an amount at least 10 wt %, e.g., at least 20 wt % or at least 25 wt %. In terms of upper limits, the taste modifier composition is present in the sweetener/sweetness enhancer composition in an amount less than 55 wt %, e.g., less than 45 wt % or less than 35 wt %.

In one embodiment, the stevia-based sweetener is present in the sweetener/sweetness enhancer composition in an amount ranging from 70 wt % to 99.95 wt %, e.g., from 80 wt % to 99.9 wt %, from 90 wt % to 99.9 wt %, from 80 wt % to 99 wt %, from 85 wt % to 99.5 wt %, from 90 wt % to 99 wt %, from 80 wt % to 95 wt %, or from 85 wt % to 97 wt %. In terms of lower limits, the stevia-based sweetener is present in the sweetener/sweetness enhancer composition in an amount at least 70 wt %, e.g., at least 80 wt %, at least 85 wt %, or at least 90 wt %. In terms of upper limits, the stevia-based sweetener is present in the sweetener/sweetness enhancer composition in an amount less than 99.95 wt %, e.g., less than 99.9 wt %, less than 99.5 wt %, less than 99 wt %, less than 97 wt %, or less than 95 wt %.

In one embodiment, the stevia-based sweetener is present in the sweetener/sweetness enhancer composition in an amount ranging from 85 wt % to 99.5 wt %, e.g., from 89 wt % to 99 wt % or from 91 wt % to 98 wt %. In terms of lower limits, the stevia-based sweetener is present in the sweetener/sweetness enhancer composition in an amount at least 85 wt %, e.g., at least 89 wt % or at least 91 wt %. In terms of upper limits, the stevia-based sweetener is present in the sweetener/sweetness enhancer composition in an amount less than 99.5 wt %, e.g., less than 99 wt % or less than 98 wt %.

In one embodiment, the stevia-based sweetener is present in the sweetener/sweetness enhancer composition in an amount ranging from 45 wt % to 90 wt %, e.g., from 55 wt % to 80 wt % or from 65 wt % to 75 wt %. In terms of lower limits, the stevia-based sweetener is present in the sweetener/sweetness enhancer composition in an amount at least 45 wt %, e.g., at least 59 wt % or at least 65 wt %. In terms of upper limits, the s is present in the sweetener/sweetness enhancer composition in an amount less than 90 wt %, e.g., less than 80 wt % or less than 75 wt %.

In one embodiment of the invention, the sweetener/sweetness enhancer composition of the invention is liquid at ambient conditions. In another embodiment of the invention, the sweetener/sweetness enhancer composition of the invention is solid at ambient conditions.

The sweetener/sweetness enhancer composition or the consumable product composition of the present invention may contain further additives known to those skilled in the art. These additives include but are not limited to dust control agents, bubble forming agents, surfactants, emulsifiers, slats, fats, gums, hydrocolloids, bulking agents, carriers, fibers, flavoring ingredients, flavor enhancers, flavor stabilizers, acidulants, anti-caking and free-flow agents. Such additives are for example described by H. Mitchell (H. Mitchell, “Sweeteners and Sugar Alternatives in Food Technology”, Backwell Publishing Ltd, 2006, which is incorporated herein by reference in its entirety).

The form of the sweetener/sweetness enhancer composition may vary widely. For example in one embodiment, the sweetener/sweetness enhancer composition may be a fine, white powder. In one embodiment the sweetener/sweetness enhancer composition is a fine white-yellow powder.

The sweetener/sweetness enhancer composition may take any suitable form including, but not limited to, an amorphous solid, a crystal, a powder, a tablet, a liquid, a cube, a glace or coating, a granulated product, an encapsulated form abound to or coated on to carriers/particles, wet or dried, or combinations thereof. In a preferred embodiment, the sweetener/sweetness enhancer composition is a liquid at ambient conditions. In another embodiment, the sweetener/sweetness enhancer composition is a solid at ambient conditions.

Unless otherwise stated, all measurement numbers are presumed to have the word “about” in front of them if the word “about” is not expressly used. As used herein, the term “about” encompasses the range of experimental error that occurs in any measurement.

As used herein, the phrase “sweetness comparable” means that an experienced sensory evaluator, on average, will determine that the sweetness presented in a first composition is within a range of 80% to 120% of the sweetness presented in a second composition. The phrase “a sweetness comparable” relates to a determination ascertained by four or more experienced sensor evaluators in a sweetness matching test (designated hereinafter as “taste and spit assay”). Thus, for instance, 100 mg/ml of a sweetener composition provides “sweetness comparable” to 100 mg/ml of sucrose if the sweetener composition has a sweetness falling within the range of sweetness presented in 80-120 mg/ml of sucrose.

The sweetness properties of the sweetener/sweetness enhancer composition, in some embodiments, can be identified by an in vitro in cell based assay as described in EP 1 865 316 B1, which is incorporated herein by reference, or by field effector transistor technology of e.g. Alpha MOS.

The taste of the sweetener/sweetness enhancer composition with regard to sweetness and/or sweetness enhancing properties and/or other tastes, in other embodiments, may be assessed in vivo by using a panel of trained sensory evaluators experienced in the sweet taste estimation procedure, e.g. in a taste and spit assay.

The taste modifier properties of the taste modifier composition as defined above may also be assessed using a taste and spit assay.

A taste and spit assay may also been used for assessing whether the effect of the composition remains at least as long as the taste of the at least one sweetener or the at least one sweetness enhancer is perceived. A taste and spit assay may also be used in the analyses of other taste-related determinations and/or assessments.

In these cases, panelists are asked to take a sample of the liquid to be assessed, e.g. the sweetener composition comprising a composition as defined above, into the mouth and after some time allowed for taste perception to spit the sample out completely. Subsequently, the panelists are asked to rinse their mouth well with water or black tea to reduce any potential carry over effects. The tasting of a sample can be repeated if required.

In a first descriptive test (qualitative assessment of the sweetener composition comprising the composition as defined above for sweetness, off-taste, aftertaste and/or lingering sweetness) the panelists are asked to taste the quality of single samples (maximum 3 subsequent samples). The individuals of the taste panel are asked to answer the following questions with regard to the quality of taste: 1) does the sample taste sweet?, 2) is there another taste detectable (e.g. bitter, sour, salty, umami etc.)?, 3) is there any off- or aftertaste or lingering sweetness?, 4) is there anything else remarkable in the perception of the sample (e.g. rich taste)?

In a second test (qualitative assessment for taste masking properties of the composition as defined above) the panelists are asked to answer questions in a pairwise comparison test to determine the taste modifier properties of the composition as defined above. In this test the taste of the sweetener composition comprising the composition as defined above is pairwise compared to the taste of the respective sweetener composition without the composition as defined above. Again the panelists are given samples. Two samples are prepared for direct comparison regarding sweetness, off-taste, aftertaste and lingering sweetness.

One sample contains the sweetener composition without the composition as defined above in a solvent. The other sample contains the sweetener composition comprising the composition as defined above. Designation of the samples with A and B is randomized and is decoded after the taste procedure. The questions to be answered are: 1) does one sample taste sweeter than the other?, 2) if so, which one?, 3) are there any other differences in the taste between the two samples? The result of the taste and spit assay is a qualitative evaluation of the differences between the two samples.

### Methods of Making the Sweetener/Sweetness Enhancer Composition

In another embodiment, the present invention relates to a method of providing a sweetener/sweetness enhancer composition, comprising the step of adding to a stevia-based sweetener the taste modifier composition to yield the sweetener/sweetness enhancer composition. As a result of the addition of the taste modifier composition, the sweetener/sweetness enhancer composition has a reduced level of unpleasant taste features, e.g. substantially no unpleasant taste features.

In one embodiment, the taste modifier compositions, sweetener/sweetness enhancer compositions are formulated into tabletop sweetener compositions. Tabletop sweetener compositions are known as are formulation methods.

### Liquid Sweetener/Sweetness Enhancer Composition

In one embodiment, the invention relates to a liquid sweetener composition comprising a solvent in combination with the sweetener/sweetness enhancer composition discussed herein. The solvents may vary widely and many food grade solvents are well known in the industry. Preferably, the solvent is water.

The sweetener/sweetness enhancer composition may be combined with the solvent as is known in the art.

The sweetener/sweetness enhancer composition may be present in the liquid sweetener composition in an amount ranging from 50 ppm to 200 ppm, e.g., from 75 ppm to 175 ppm, from 90 ppm to 160 ppm, or from 100 ppm to 135 ppm. In terms of lower limits the sweetener/sweetness enhancer composition may be present in the liquid sweetener composition in an amount at least 50 ppm, e.g., at least 75 ppm, at least 90 ppm, or at least 100 ppm. In terms of upper limits, the sweetener/sweetness enhancer composition may be present in the liquid sweetener composition in an amount less than 200 ppm, e.g., less than 175 ppm, less than 160 ppm, or less than 135 ppm. These ranges and limits are based on the total weight of the liquid sweetener composition. The solvent may make up the remainder of the liquid sweetener composition.

The sweetener/sweetness enhancer composition may be present in the liquid sweetener composition in an amount ranging from 1 ppm to 100 ppm, e.g., from 2 ppm to 40 ppm, from 5 ppm to 25 ppm, or from 10 ppm to 24 ppm. In terms of lower limits the sweetener/sweetness enhancer composition may be present in the liquid sweetener composition in an amount at least 1 ppm, e.g., at least 2 ppm, at least 5 ppm, or at least 10 ppm. In terms of upper limits, the sweetener/sweetness enhancer composition may be present in the liquid sweetener composition in an amount less than 100 ppm, e.g., less than 40 ppm, less than 25 ppm, or less than 24 ppm. These ranges and limits are based on the total weight of the liquid sweetener composition. The solvent may make up the remainder of the liquid sweetener composition.

### Consumable Product Compositions

The taste modifier composition and the sweetener/sweetness enhancer compositions can be added to any consumable products including but not limited to beverages, dental products, cosmetic products, pharmaceutical products and animal feed or animal food, in particular to beverages. The compositions of the invention as described above can be added to any consumable products, which are produced in a household or on a small scale. Such consumable products may contain an amount of natural sugar.

Thus, in one embodiment, the invention relates to a consumable product composition comprising (a) a consumable product; and (b) the taste modifier composition; or (a) a consumable product; and (b) the sweetener/sweetness enhancer composition.

In one embodiment, the balsamic compound is present in the consumable product in an amount ranging from 0.01 wppb to 110 wppm, e.g., from 0.05 wppb to 50 wppm, 0.05 wppb to 25 wppm, from 0.01 wppb to 10 wppm, from 0.05 wppb to 0.5 wppb, or from 0.1 wppb to 10 wppm. In one embodiment, the balsamic is present in the consumable product composition in an amount at least 0.01 wppb, e.g., at least 0.05 wppb, or at least 0.1 wppb. In one embodiment, the balsamic compound is present in the consumable product composition in an amount less than 110 wppm, e.g., less than 50 wppm, less than 25 wppm, less than 10 wppm, less than 1 wppm, less than 100 wppb, less than 10 wppb, or less than 1 wppb.

In one embodiment, the balsamic compound is present in the consumable product in an amount ranging from 0.2 wppm to 100 wppm, e.g., from 0.2 wppm to 50 wppm, 0.2 wppm to 20 wppm, from 0.2 wppm to 10 wppm, from 0.5 wppm to 5 wppm, or from 0.5 wppm to 5 wppm. In one embodiment, the balsamic compound is present in the consumable product composition in an amount at least 0.2 wppm, e.g., at least 0.5 wppm, or at least 1 wppm. In one embodiment, the balsamic compound is present in the consumable product composition in an amount less than 100 wppm, e.g., less than 50 wppm, less than 20 wppm, less than 10 wppm, or less than 5 wppm.

In one embodiment, when the taste modifier composition comprises a plant extract, the plant extract is present in the consumable product composition in an amount ranging from 0.001 wppb to 110 wppm, e.g., from 0.01 wppb to 50 wppm, or from 0.1 wppb to 10 wppm. In one embodiment, the plant extract is present in the consumable product composition in an amount at least 0.001 wppb, e.g., at least 0.01 wppb, or at least 0.1 wppb. In one embodiment, the plant extract is present in the consumable product composition in an amount less than 110 wppm, e.g., less than 50 wppm, or less than 10 wppm.

In one embodiment, when the taste modifier composition comprises an amino acid, the amino acid is present in the consumable product composition in an amount ranging from 0.1 wppb to 6 wppm, e.g., from 1 wppb to 5 wppm, or from 10 wppb to 1 wppm. In one embodiment, the amino acid is present in the consumable product composition in an amount at least 0.1 wppb, e.g., at least 1 wppb, or at least 10 wppb. In one embodiment, the amino acid is present in the consumable product composition in an amount less than 6 wppm, e.g., less than 5 wppm, or less than 1 wppm.

In one embodiment, when the taste modifier composition comprises a lactone, the lactone is present in the consumable product composition in an amount ranging from 0.2 wppb to 15 wppm, e.g., from 1 wppb to 5 wppm, or from 10 wppb to 1 wppm. In one embodiment, the lactone is present in the consumable product composition in an amount at least 0.2 wppb, e.g., at least 1 wppb, or at least 10 wppb. In one embodiment, the lactone is present in the consumable product composition in an amount less than 15 wppm, e.g., less than 5 wppm, or less than 1 wppm.

In one embodiment, when the taste modifier composition comprises a bitter blocker, the bitter blocker is present in the consumable product composition in an amount ranging from 0.5 wppm to 200 wppm, e.g., from 1 wppm to 150 wppm, or from 10 wppm to 100 wppm. In one embodiment, the bitter blocker is present in the consumable product composition in an amount at least 0.5 wppm, e.g., at least 1 wppm, or at least 10 wppm. In one embodiment, the bitter blocker is present in the consumable product composition in an amount less than 200 wppm, e.g., less than 150 wppm, or less than 100 wppm.

In one embodiment, when the taste modifier composition comprises maltol, the maltol is present in the consumable product composition in an amount ranging from 0.2 wppm to 300 wppm, e.g., from 1 wppm to 200 wppm, or from 10 wppm to 150 wppm. In one embodiment, the maltol is present in the consumable product composition in an amount at least 0.2 wppm, e.g., at least 1 wppm, or at least 10 wppm. In one embodiment, the maltol is present in the consumable product composition in an amount less than 300 wppm, e.g., less than 200 wppm, or less than 150 wppm.

In one embodiment, when the taste modifier composition comprises sodium chloride, the sodium chloride is present in the consumable product composition in an amount ranging from 10 wppm to 500 wppm, e.g., from 25 wppm to 400 wppm, or from 100 wppm to 300 wppm. In one embodiment, the sodium chloride is present in the consumable product composition in an amount at least 10 wppm, e.g., at least 25 wppm, or at least 100 wppm. In one embodiment, the sodium chloride is present in the consumable product composition in an amount less than 500 wppm, e.g., less than 400 wppm, or less than 300 wppm.

In one embodiment, when the taste modifier composition comprises trehalose, the trehalose is present in the consumable product composition in an amount ranging from 0.1 wppm to 1000 wppm, e.g., from 1 wppm to 750 wppm, or from 10 wppm to 500 wppm. In one embodiment, the trehalose is present in the consumable product composition in an amount at least 0.1 wppm, e.g., at least 1 wppm, or at least 10 wppm. In one embodiment, the trehalose is present in the consumable product composition in an amount less than 1000 wppm, e.g., less than 750 wppm, or less than 500 wppm.

Table 2 shows exemplary individual weight percentage ranges and limits components for several potential components of the taste modifier composition (in the consumer product composition. The limits in the table may be combined to form the respective range.

TABLE 2
Exemplary Component Weight ppm Limits
and Ranges for Consumable Product Compositions

| Component | Low 1 | High 1 |
|---|---|---|
| Trehalose | 0.1 | 1000 |
| Sodium Chloride | 10 | 500 |
| Benzoin (abs.) | 0.02 | 100 |
| Maltol | 0.2 | 300 |
| Naringin | 0.5 | 200 |
| d-Dodecalactone | 0.0020 | 5.0000 |
| Massoialactone | 0.0020 | 5.0000 |
| d-decalactone | 0.0002 | 5.0000 |
| Valine | 0.0001 | 1.0000 |
| Acetoin | 0.0001 | 1.0000 |
| Pimento berry oil | 0.00001 | 1.0000 |
| Ethylpalmitate | 0.0001 | 3.0000 |
| Sandalwood oil | 0.00001 | 1.0000 |
| Balsam extract | 0.00001 | 2.0000 |
| Proline | 0.0001 | 1.0000 |
| Leucine | 0.0001 | 1.0000 |
| Serine | 0.0001 | 1.0000 |
| Tyrosine | 0.0001 | 1.0000 |
| Glutamic acid | 0.0001 | 1.0000 |
| 2,3-pentadione | 0.0001 | 0.5000 |
| Caraway oil | 0.0001 | 2.0000 |
| Cassia oil | 0.0001 | 2.0000 |
| Dimethylanthranilate | 0.0001 | 2.0000 |
| Ethyllaurate | 0.0001 | 2.0000 |
| Ginger oil | 0.0001 | 2.0000 |
| Sinensal | 0.0001 | 1.0000 |

The following consumable products and their ingredients are suitable for use in embodiments of the present invention.

Consumable products include all food products, including but not limited to cereal products, rice products, tapioca products, sago products, baker's products, biscuit products, pastry products, bread products, confectionery products, desert products, gums, chewing gums, chocolates, ices, honey products, treacle products, yeast products, baking-powder, salt and spice products, savoury products, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, pharmaceuticals, beverages, carbonated beverages, alcoholic drinks, beers, soft drinks, mineral and aerated waters and other non-alcoholic drinks, fruit drinks, fruit juices, coffee, artificial coffee, tea, cacoa, including forms requiring reconstitution, food extracts, plant extracts, meat extracts, condiments, sweeteners, nutraceuticals, gelatins, pharmaceutical and non-pharmaceutical gums, tablets, lozenges, drops, emulsions, elixirs, syrups and other preparations for making beverages, and combinations thereof.

As used herein, the term “non-alcoholic drinks” includes, but is not limited to all non-alcoholic drinks mentioned in the Directive 2003/115/EC of 22 Dec. 2003 and in the Directive 94/35/EC of 30 Jun. 2004, which are incorporated herein by reference, on sweeteners for use in foodstuffs. Examples include, but are not limited to water-based, flavored drinks, energy-reduced or with no added sugar, milk- and milk-derivative-based or fruit-juice-based drinks, energy-reduced or with no added sugar, “Gaseosa”: non-alcoholic water-based drink with added carbon dioxide, sweeteners and flavorings.

Consumable products include without limitation, water-based consumable products, solid dry consumable products, dairy products, dairy-derived products and dairy-alternative products.

In one embodiment, the consumable product is a water-based consumable product selected from the group consisting of beverage, water, near water drink, aqueous beverage, enhanced/slightly sweetened water drink, flavored carbonated and still mineral and table water, non-carbonated beverage, carbonated water, still water, soft drink, carbonated soft drink, non-alcoholic drink, alcoholic drink, beer, wine, liquor, fruit drink, juice drink, juice, fruit juice, vegetable juice, nectar, broth drink, coffee, tea, black tea, green tea, oolong tea, herbal infusion, cacoa (water-based), tea-based drink, coffee-based drinks, cacao-based drink, dessert, syrup, frozen fruit, frozen fruit juice, water-based ice, fruit ice, sorbet, dressing, salad dressing, jams, marmalades, canned fruit, savoury, delicatessen products like delicatessen salads, sauces, ketchup, mustard, pickles and marinated fish, sauce, soup, and beverage botanical materials (whole or ground), or instant powder for reconstitution (coffee beans, ground coffee, instant coffee, cacao beans, cacao powder, instant cacao, tea leaves, instant tea powder).

Near water drinks as used herein, are drinks comprising lower sensory attributes in terms of sweetness, acidity, flavor, color compared to other categories. Near water drinks are containing the major traditionally used ingredients known in the beverage industry but at lower dosage to achieve a character closer to water.

In another embodiment, the consumable product is a solid dry consumable product selected from the group consisting of cereals, baked food products, biscuits, bread, breakfast cereal, cereal bar, energy bars/nutritional bars, granola, cakes, rice cakes, cookies, crackers, donuts, muffins, pastries, confectioneries, chewing gum, chocolate products, chocolates, fondant, candy, hard candy, marshmallow, pressed tablets, snack foods, botanical materials (whole or ground), and instant powders for reconstitution.

In another embodiment, the consumable product is a dairy product, dairy-derived product and/or dairy-alternative product selected from the group consisting of milk, fluid milk, cultured milk product, cultured and noncultured dairy-based drink, cultured milk product cultured with lactobacillus, yoghurt, yoghurt-based beverage, smoothy, lassi, milk shake, acidified milk, acidified milk beverage, butter milk, kefir, milk-based beverages, milk/juice blend, fermented milk beverage, icecream, dessert, sour cream, dip, salad dressing, cottage cheese, frozen yoghurt, soy milk, rice milk, soy drink, and rice milk drink.

In a preferred embodiment, the consumable product is a beverage.

In a particularly preferred embodiment, the beverage is a near water drink, a tea-based drink, a carbonated soft drink, a juice drink or nectar.

In a particularly preferred embodiment, the consumable product is a tea-based drink comprising the sweetener composition or the sweetness enhancer composition.

In a preferred embodiment, the consumable product composition is a tea-based drink.

In a particularly preferred embodiment, the consumable product is a carbonated soft drink comprising the sweetener composition or the sweetness enhancer composition.

In a particularly preferred embodiment, the consumable product is a juice drink.

In another embodiment, the consumable products are alcoholic beverages and the invention relates to alcoholic beverages comprising a sweetener composition of the invention or a tabletop sweetener composition of the invention, preferably to shandy beer, wine cooler, wildberry cooler (e.g., 5% alcohol), strawberry daiquiri cooler (e.g., 5% alcohol), margarita cooler (e.g., 5% alcohol) and raspberry cooler. In addition, the alcoholic beverages may contain further substances including but not limited to acesulfame potassium, aspartame, beer, color, citric acid monohydrate, cyclamate, fruit juice (e.g. peach, pineapple), lemon flavor, margarita flavor, rum flavor, sucrose, vodka, wildberry flavor, wine and water.

In another embodiment, the consumable products are fruit juices and the invention relates to fruit juices comprising a sweetener composition of the invention or a tabletop sweetener composition of the invention, preferably to functional fruit drinks (e.g., 30% fruit juice content), fruit nectar, fruit juice drinks, no sugar added fruit beverages (e.g., 5% juice, kiwi-strawberry flavored) and ruby red grapefruit and tangerine juice drinks (from concentrate). In addition, the fruit juices may contain further substances including but not limited to acesulfame potassium, aspartame, anthocyane, ascorbic acid, carotinoids, citric acid (e.g., anhydrous), cyclamate, luteine, fruit concentrate, fruit juice concentrate, flavor, fruit, grapefruit pulp cells, grapefruit flavor, kiwi juice concentrate, kiwi-strawberry flavor, malic acid, pectin, ruby red grapefruit concentrate, strawberry juice concentrate, tangerine juice concentrate, tangerine flavor, grape extract, vegetable extract (e.g., pumpkin, carrot, aronia, blackcurrant, hibiscus etc.) and water.

In another embodiment, the consumable product is ice tea and the invention relates to ice tea comprising a sweetener composition of the invention or a tabletop sweetener composition of the invention, preferably to ice tea and sugar free ice tea mix. In addition, the ice tea may contain further substances including but not limited to base with lemon flavor, base with tea component, citric acid, cyclamate, flavor, instant tea, lemon juice, maltodextrin, malic acid (e.g., powdered), saccharin, sucralose, sucrose, tea and tea extract.

In another embodiment, the consumable products are soft drinks without sugar and the invention relates to soft drinks without sugar comprising a sweetener composition of the invention or a tabletop sweetener composition of the invention, preferably to soft drinks Cola flavored, fruit nectars, fruit juice drinks, soft drinks, soft drinks lemon lime flavored, diet sparkling waters (e.g., peach flavored) and sugar free liquid beverages. In addition, the soft drinks without sugar may contain further substances including but not limited to acesulfame potassium, alitame, aspartame, bilberry flavor, citric acid monohydrate, caffeine, cola flavor, cyclamate, peach flavor, potassium citrate, sodium-cyclamate, grape color, grape flavor, sodium benzoate, sodium citrate, sodium-saccharin, ethylmaltol, flavor, lemon-lime flavor, maltol, neotame, NHDC, passion fruit flavor, pectin, phosphoric acid (85%), saccharin, sucralose and water.

In another embodiment, the consumable products are soft drinks with sugar and the invention relates to soft drinks with sugar comprising a sweetener composition of the invention or a tabletop sweetener composition of the invention. In addition, the soft drinks with sugar may contain further substances including but not limited to acesulfame potassium, aspartame, citric acid monohydrate, concentrate, caffeine, flavor, fructose, glucose, glucose syrup, high fructose con syrup (HFCS, e.g., HFCS having total solids: approx. 77%, fructose: 55% and glucose: 41%), neotame, orangeade base, phosphoric acid (e.g., 85%), sodium-cyclamate, sucrose and water.

In another embodiment, the consumable products are sports drinks and the invention relates to sports drinks comprising a sweetener composition of the invention or a tabletop sweetener composition of the invention, preferably to isotonic energy drinks and whey drinks. In addition, the sports drinks may contain further substances including but not limited to acesulfame potassium, aspartame, ascorbic acid, concentrate, caffeine, citric acid, flavor, glucose (e.g., anhydrous), herbs, minerals, neohesperidine-DC, natural extracts, sucralose, taurine, vitamins, water and whey powder.

In another embodiment, the consumable products are dry powder beverages and the invention relates to dry powder beverages comprising a sweetener composition of the invention or a tabletop sweetener composition of the invention. In addition, the dry powder beverages may contain further substances including but not limited to acesulfame potassium, aspartame, apple flavor, ascorbic acid, citric acid, cherry flavor, malic acid, orange flavor, raspberry flavor, sodium chloride, trisodium citrate, tricalcium phosphate, titanium dioxide and xantham gum.

In another embodiment, the consumable product is ice coffee and the invention relates to ice coffee comprising a sweetener composition of the invention or a tabletop sweetener composition of the invention. In addition, the ice coffee may contain further substances including but not limited to acesulfame potassium, aspartame, coffee extract, ethylmaltol, flavor and neohesperidine-DC.

In another embodiment, the consumable products are instant cake fillings and the invention relates to instant cake fillings comprising a sweetener composition of the invention or a tabletop sweetener composition of the invention. In addition, the cake fillings may contain further substances including but not limited to milk, isomalt, oligofructose, modified starch, flavors and colors. In another embodiment, the cake fillings may contain further substances including but not limited to raspberries, strawberry puree, polydextrose, isomalt, sorbitol, glycerin, fructose, pectin, locust bean gum, calcium chloride, sodium bicarbonate, citric acid and water.

In another embodiment, the consumable products are biscuits and the invention relates to biscuits comprising a sweetener composition of the invention or a tabletop sweetener composition of the invention. In addition, the biscuits may contain further substances including but not limited to isomalt, powdered isomalt, granulated isomalt, polydextrose, shortening, water, sodium bicarbonate, ammonium bicarbonate, skimmed milk powder, salt, flour, cake flour, flavor, inulin, wheat fiber, shortening, ground raisins, raisin paste, salt, oatrim gel, liquid whole eggs, liquid egg whites, powdered egg whites, egg yolk, vanilla, butter flavor, vanilla flavor, chocolate flavor, cocoa, high fructose corn syrup (HFCS), methocel, baking soda, cinnamon, sodium acid pyrophosphate, margarine spread, margarine, emulsifier, molasses, mono- and diglycerides, powdered cellulose, ground hazelnuts, hazelnuts, sorbitol, oat fiber, vital wheat gluten, chocolate chips, maltitol and fat replacer.

In another embodiment, the consumable products are cakes and the invention relates to cakes comprising a sweetener composition of the invention or a tabletop sweetener composition of the invention. In addition, the cakes may contain further substances including but not limited to baking powder, baking soda, blueberry flavor, all purpose flour, cake flour, diacetyl 4×, dextrose, dried butter flavor, flour, cellulose, crystalline fructose, emulsifier, egg whites solid, eggs, dried egg white, fat replacers such as inulin, isomalt, lecithin, milk, non fat dry milk, modified starch, maltodextrin, oligofructose, potato fiber, polydextrose, salt, shortening, crystalline sorbitol, sodium aluminium phosphate, sucrose, butter flavor, chocolate flavor, (dried) vanilla flavor, water, wheat fiber, xanthan gum and vegetable oil.

In another embodiment, the consumable products are bakery products other than cakes and the invention relates to bakery products other than cakes comprising a sweetener composition of the invention or a tabletop sweetener composition of the invention, preferably to light hot fudge toppings, tartlets with strawberry fillings, sugar free maple flavored syrups, sugar free dark chocolate coatings, sugar free chocolate syrups, reduced-calorie chocolate syrups, no sugar added caramel corn, light chocolate frostings, light caramel toppings and light apple tart. In addition, the bakery products may contain further substances including but not limited to acesulfame potassium, aspartame, baking powder, baking soda, disodium phosphate, maple flavor, caramel flavor, caramel color, flour, carrageenan, cocoa powder, cocoa butter, (microcrystalline) cellulose, citric acid, calcium chloride, crystalline fructose, fructose, chocolate liquor, eggs, dried egg white, fudge flavor, isomalt, lecithin, non fat dry milk, hydrogenated starch hydrolysate, margarine, modified starch, maltisorb, maltodextrin, nonfat dry milk, oligofructose, potassium sorbate, pectin, potato fiber, hydrogenated potato starch, polydextrose, skimmed milk powder, shortening, (crystalline) sorbitol, sodium benzoate, salt, sorbitol, potassium sorbate, (powdered) sucrose, butter flavor, chocolate flavor, vanillin, (dried) vanilla flavor, water, wheat fiber and xanthan gum.

In another embodiment, the consumable products are confectionary products and the invention relates to confectionary products comprising a sweetener composition of the invention or a tabletop sweetener composition of the invention, preferably to all confectionary products mentioned in the Directive 2003/115/EC of 22 Dec. 2003 and in the Directive 94/35/EC of 30 Jun. 2004 on sweeteners for use in foodstuffs, each of which are incorporated herein by reference. Examples include, but are not limited to, confectionaries (with or without added sugar), cocoa- or dried-fruit-based confectionaries, energy-reduced or with not added sugar, starch-based confectionaries, energy-reduced or with not added sugar, cornets and wafers for ice-cream, with not added sugar, Essoblaten, cocoa-, milk-, dried-fruit- or fat-based sandwich spreads, energy-reduced or with not added sugar, breakfast cereals, e.g., with a fiber content of more than 15%, and containing at least 20% bran, energy-reduced or sugar-reduced, breath-freshening micro-sweets with or without added sugar, strongly flavored freshening throat pastilles with or without added sugar, chewing gum with or without added sugar, energy-reduced tablet form confectioneruies, cider and perry, drinks consisting of a mixture of a non-alcoholic drink and beer, cider, perry, spirits or wine, spirit drinks containing less than 15% alcohol by volume, alcohol-free beer or beer with an alcohol content not exceeding 1.2% vol., “bière de table/Tafelbier/table beer” (original wort content less than 6%), except for “obergäriges Einfachbier”, beers with a minimum aciditiy of 30 milli-equivalents expressed as NaOH, brown beers of the “oud bruin” type, energy-reduced beer, edible ices, energy-reduced or sugar-reduced canned or bottled fruit, energy-reduced or with or without added sugar, energy-reduced jams, jellies and marmalades, energy-reduced fruit and vegetable preparations, sweet-sour preserves of fruit and vegetables, Feinkostsalat, sweet-sour preserves and semi-preserves of fish and marinades of fish, crustaceans and mollusks, energy-reduced soups, sauces, mustard, fine bakery products for special nutritional uses, foods intended for use in energy-restricted diets for weight reduction as referred to in Directive 1996/8/EC, dietary foods for special medical purposes as defined in Directive 1999/21/EC, food supplements as defined in Directive 2002/46/EC supplied in a liquid form, food supplements as defined in Directive 2002/46/EC supplied in a solid form, food supplements as defined in Directive 2002/46/EC, based on vitamins and/or mineral elements and supplied in a syrup-type or chewable form. These Directives are incorporated herein by reference. Particularly preferred confectionary products are sugar free hard candy, reduced calorie no sugar added hard candy, hard candies, sugar free milk chocolate, milk chocolate, sugar free gummy bear, reduced calorie no sugar added gummy bear, sugar free dark chocolate, reduced calorie no sugar added hard candy, reduced calorie no sugar added caramel, reduced calorie caramel, raspberry jellies, jellies, plain bitter chocolate, toffees, sugar-free rice cake, sugar free peppermint breathmint, sugar free orange chewy candy and sugar free jelly beans. In addition, the confectionary products may contain further substances including but not limited to butter fat, (caramel) flavor, citric acid (monohydrate), cherry flavor, chocolate liquor, cocoa butter, cocoa mass, color, corn syrup, (microcrystalline) cellulose, disodium phosphate, egg Albumen-dried, evaporated milk, gelatin, glycerol monostearate, gum Arabic, hydrogenated starch hydrolysate, hydrogenated fat, isomalt, lecithin, lemon oil, maltitol (syrup, powdered and/or granular), medium-grain brown rice, Korean black rice, maltol, mocha paste, neohesperidine-DC, orange flavor, pectin, peppermint flavor, polydextrose, raspberry puree, raspberry puree, salt, sodium caseinate, sorbitol (powder), starch, sucrose, vanillin, vegetable fat, whole milk powder, skimmed milk powder, water and xylitol.

U.S. Pat. Nos. 6,627,233; 5,698,181; 5,688,491; 5,451,404; and 5,009,893 are hereby incorporated by reference in their entireties, including, but not limited to, the flavorings, sweeteners, sweetness enhancers, additional flavoring ingredients, solutions, consumables, consumable compositions, and formulations that are disclosed therein.”

In another embodiment, the consumable products are delicacies sauces and the invention relates to delicacies sauces comprising a sweetener composition of the invention or a tabletop sweetener composition of the invention, preferably to sugar reduced ketchup with sugar, no added sugar Ketchup and tomato ketchup. In addition, the delicacies sauces may contain further substances including but not limited to citric acid, modified starch, mustard, onions, pectin, polydextrose, saccharine sodium, salt, spices, sucralose, sugar, thickener, tomato concentrate and vinegar.

In another embodiment, the consumable products are cereals and the invention relates to cereals comprising a sweetener composition of the invention or a tabletop sweetener composition of the invention.

In another embodiment, the consumable products are dairy products and the invention relates to dairy products comprising a sweetener composition of the invention or a tabletop sweetener composition of the invention, preferably to fruit quarks, whipped creams, (vanilla flavored skim) milk drinks and yoghurt drinks. In addition, the dairy products may contain further substances including but not limited to acesulfame potassium, aspartame, blackcurrant, blackberry, blueberry, cyclamate, flavor, fruit preparation, fruit juice concentrate, fructose, gelatin, inulin, oat, orange juice, pectin, raspberry, redcurrant, stabilizer, wheat fiber, water, quarks, yoghurt, whipped cream and whey.

In another embodiment, the consumable products are desserts and the invention relates to desserts comprising a sweetener composition of the invention or a tabletop sweetener composition of the invention, preferably to jellied red fruit cocktails, strawberry sorbet, (fat-free/sugar-free) instant pudding chocolate flavors, instant desserts, vanilla puddings, vanilla pudding—powder mixtures and litchee gelees. In addition, the desserts may contain further substances including but not limited to acesulfame potassium, aspartame, blackberries, brandy, citric acid, caramel color, color, cyclamate, chocolate flavor, cocoa powder, corn starch, disodium phosphate, emulsifier, fructose, granulated sugar, white soft sugar, agar powder, ingestible dextrin, mannan, maltodextrin, mono- and diglycerides, inulin, polydextrose, lemon juice, maltodextrin, milk modified food starch, polydextrose, raspberries, redcurrant juice, salt, soy lecithin, strawberries, strawberry puree, tetrasodium pyrophosphate, litchee flavor, vanilla flavor, wheat starch, water and xanthan gum.

As used herein, the term “desserts” includes, but is not limited to all desserts mentioned in the Directive 2003/115/EC of 22 Dec. 2003 and in the Directive 94/35/EC of 30 Jun. 2004 on sweeteners for use in foodstuffs. These Directives are incorporated herein by reference. Examples include, but are not limited to water-based flavored desserts, energy-reduced or with not added sugar, milk- and milk-derivative-paste preparations, energy-reduced or with no added sugar, fruit-and-vegetable-based desserts, energy-reduced or with no added sugar, egg-based desserts, energy-reduced or with no added sugar, cereal-based desserts, energy-reduced or with no added sugar, breakfast cereals or cereal-based products, energy-reduced or with no added sugar, fat-based desserts, energy-reduced or with no added sugar, edible ices, energy-reduced or with no added sugar, jams, jellies, marmalades and crystallized fruit, energy-reduced or with no added sugar, fruit preparations, energy-reduced or with no added sugar, and “snacks”, certain flavors of ready-to-eat, prepacked, dry, savoury starch products and coated nuts.

In another embodiment, the consumable product is water-based ice and the invention relates to water-based ice comprising a sweetener composition of the invention or a tabletop sweetener composition of the invention, preferably to “ice-pops” and no sugar added strawberry sorbet. In addition, the water-based ice may contain further substances including but not limited to acesulfame potassium, aspartame, citric acid, color, fruit concentrate, flavor, isomalt, lemon juice, polydextrose, strawberry puree, sorbitol, thickener and water.

In another embodiment, the consumable product is ice cream and the invention relates to ice cream comprising a sweetener composition of the invention or a tabletop sweetener composition of the invention. In addition, the ice-cream may contain further substances including but not limited to color, emulsifier, flavor, isomalt, milk fat, fat replacer, skim milk powder, polydextrose and lactitol.

In another embodiment, the consumable product is yoghurt and the invention relates to yoghurt comprising a sweetener composition of the invention or a tabletop sweetener composition of the invention. In addition, the yoghurt may contain further substances including but not limited to acesulfame potassium, alitame, aspartame, citric aid monohydrate, tri-calcium-dicitrate, cyclamate, Na-cyclamate, fruit preparation, high fructose corn syrup (HFCS), inulin, fructose, fructose syrup, oligofructose syrup, neohesperidine-DC, pectin-solution, saccharin, starch, strawberries, strawberry-flavor, sucralose, water and (low fat, preferably between 0.1% to 1.5% fat) yoghurt.

In another embodiment, the consumable products are jams and the invention relates to jams comprising a sweetener composition of the invention or a tabletop sweetener composition of the invention. In addition, the jams may contain further substances including but not limited to gelling agent, isomalt, maltitol, pectin, sorbitol and strawberries.

In another embodiment, the consumable product is chewing-gum and the invention relates to chewing-gum comprising a sweetener composition of the invention or a tabletop sweetener composition of the invention.

The amount of the sweetener composition or the sweetness enhancer composition in the consumable of the invention is dependent on the concentration of the natural and or artificial sweeteners contained therein as well as on the presence of further auxiliary substances such as carbon dioxide, flavors (e.g. spices, natural extract or oils), colors, acidulants (e.g. phosphoric acid and citric acid), preservatives, potassium, sodium.

In another embodiment, the consumable product is a dental product and the invention relates to a dental product comprising a sweetener composition of the invention. Dental products include, but are not limited to toothpaste, dental floss, mouthwash, denture adhesive, enamel whitener, fluoride treatments and oral care gels. These products are also known in the art.

In a preferred embodiment the consumable product is toothpaste and the invention relates to toothpaste comprising a sweetener composition of the invention. In addition, the toothpaste may contain further substances including but not limited to abrasive silica, dicalcium phosphate dehydrate, hydrated silica (thickener), ethyl alcohol, peppermint flavor, mint flavor, potassium sorbate, sodium lauryl sulphate, sodium carboxymethylcellulose, sodium monofluorophosphate, sodium monofluorophosphate, sorbitol solution, tetrasodium phosphate and titanium dioxide.

In another embodiment, the consumable product is a cosmetic product and the invention relates to a cosmetic product comprising a sweetener composition of the invention. Cosmetic products include but are not limited to lipstick, lip balm, lip gloss, and petroleum jelly. These products are also known in the art.

In another embodiment, the consumable product is a pharmaceutical product and the invention relates to a pharmaceutical product comprising a sweetener composition of the invention. Pharmaceutical products include but are not limited to over-the-counter and prescription drugs including but not limited to non-tobacco snuff, tobacco substitutes, chewable medications, cough syrups, throat sprays, throat lozenges, cough drops, antibacterial products, pill coatings, gel caplets, soluble fiber preparations, antacids, tablet cores, rapidly absorbed liquid compositions, stable foam compositions, rapidly disintegrating pharmaceutical dosage forms, beverage concentrates for medicinal purposes, aqueous pharmaceutical suspensions, liquid concentrate compositions, and stabilized sorbic acid solutions, phosphate buffers, saline solutions, emulsion, non-aqueous pharmaceutical solvents, aqueous pharmaceutical carriers, solid pharmaceutical carrier, and pharmaceutical preservatives/additives (antimicrobials, antioxidants, chelating agents, inert gases, flavoring agents, coloring agents).

In another embodiment, the consumable product is animal feed or animal food and the invention relates to animal feed or animal food comprising a sweetener composition of the invention.

A conventional beverage may comprise from 20 g/l to 100 g/l standard sugar such as e.g. sucrose and this standard sugar may achieve a first level sweetness. It has now been found that by using the inventive sweetener composition to replace at least a portion of this standard sugar, the amount of standard sugar in a beverage can be reduced or eliminated maintaining the same sweetness level.

Preferably, the effect of the composition remains at least as long as the taste of the consumable product is perceived. Preferably, the sweetened consumable product has a rich taste.

### Examples

The following examples are non-limiting.

Sweetener/sweetness enhancer compositions were prepared using balsamic compound(s) (and other optional taste modifiers), e.g., taste modifier compositions, in combination with sucralose and other sweeteners as shown in Table 3. The components were added to distilled water and mixed to form the respective tasting solution.

TABLE 3

| | Example: | | | | | | | | | | | |
|---|---|---|---|---|---|---|---|---|---|---|---|---|
| Component | 1a | 1b | 1c | A | B | C1 | C2 | 2a | 2b | 2c | D | 3 |
| Tolu Balsam | x | x | x | x | x | x | x | x | x | x | x | x |
| Stevia-based | x | x | x | | | | | x | x | x | | x |
| swtr. | | | | | | | | | | | | |
| Ace-K | | | | | | | | x | x | x | | |
| Sucralose | | | | | | | | | | | | |
| Aspartame | | | | x | | | | | | | x | |
| Thaumatin | | | | | x | | | | | | x | |
| Sodium | | | | | | x | | | | | | |
| Cyclamate | | | | | | | | | | | | |
| Sodium | | | | | | | x | | | | | |
| Saccharin | | | | | | | | | | | | |
| Lactone(s) | | | | | | | | | | | | x |
| Ester(s) | | | | | | | | | | | | x |

The tasting solutions comprising the sweetener/sweetness enhancer compositions of Table 3 were taste tested by a panel of trained sensory evaluators. Comparisons were made to a tasting solution comprising only the respective sweetener, e.g., only sucralose or only aspartame and no balsamic compound.

All tests were conducted under controlled and standardized conditions based on international norms (DIN 10962 and ISO 8589, e.g., present year). Room temperature and humidity were maintained at 20° C. and 40-70% relative humidity. Air was constantly exchanged. Panelists were seated in sensory test cabins in order to allow undisturbed individual assessment. The lighting was identical for each panelist, flexible from red-light to full day-light condition. All samples were presented according to a fully balanced experimental design. 35 ml samples were served in clear plastic cups labeled with random three digit blinding codes. All tasting solutions were served at a temperature ranging from 6.0° C. to 8.0° C. The data were collected and summarized. Neutralization between tastings was achieved by taking breaks of at least 15 minutes and by consuming neutralizing food and drinks such as still water, cucumber, white baguette, and unsalted rice crackers. All tasting solutions were tested in duplicate. The sensory results are presented in Table 4.

TABLE 4

| | Example: | | | | | | | | | | | |
|---|---|---|---|---|---|---|---|---|---|---|---|---|
| | 1a | 1b | 1c | A | B | C1 | C2 | 2a | 2b | 2c | D | 3 |
| Overall | ++ | ++ | ++ | − | − | − | − | ++ | ++ | ++ | − | ++ |
| Effect | | | | | | | | | | | | |
| Improve | yes | yes | yes | no | no | no | no | yes | yes | yes | no | yes |
| Fullness | | | | | | | | | | | | |
| Improve | yes | yes | yes | no | no | no | no | yes | yes | yes | no | yes |
| Aftertaste | | | | | | | | | | | | |
| Sweet | yes | yes | yes | no | no | no | no | yes | yes | yes | no | yes |
| Roundness | | | | | | | | | | | | |
| Sweet | no | no | no | yes | yes | yes | yes | no | no | no | yes | no |
| Decrease | | | | | | | | | | | | |

In Table 4, “++” indicates a significant, noticeable improvement on overall taste versus a tasting solution comprising only the respective sweetener. “0” indicates no effect on overall taste versus a tasting solution comprising only the respective sweetener. “−” indicates a significant, noticeable negative effect on overall taste versus a tasting solution comprising only the respective sweetener. Table 4 also indicates effects of the balsamic compound-containing sweetener/sweetness enhancer compositions on individual taste characteristics, e.g., fullness, aftertaste, roundness, and decrease in sweetness.

As shown in Table 4, the addition of the balsamic compound, e.g., tolu balsam, to the stevia-based sweetener in sweetness/sweetness enhancer compositions 1a, 1b, 1c, 2a, 2b, 2c, and 3 provided for significant improvements in overall taste effect, as compared to a tasting solution comprising only stevia-based sweetener. Importantly, the addition of balsamic compound, e.g., tolu balsam, to aspartame, thaumatin, or a mixture thereof (Comparative Examples A, B, and D) actually provided a negative overall effect, i.e., the tolu balsam actually worsened the overall taste of the aspartame or thaumatin. Also, the addition of balsamic compound, e.g., tolu balsam, to non-sucralose sweeteners, e.g., sodium cyclamate or sodium saccharine, (Examples C1 and C2) also provided a negative overall effect, i.e., the tolu balsam actually worsened the overall taste of the aspartame or thaumatin.

In addition, when the balsamic compound was added to aspartame, thaumatin, sodium cyclamate, or sodium saccharine there were no improvements to fullness, aftertaste, and roundness, and importantly, there was actually a decrease in sweetness. Thus, based on the poor results shown in comparative Examples 4, 5, 6a, and 6b, it is surprising that the balsamic compound would provide for any improvements when utilized in combination with the stevia-based sweetener.

As shown by Examples 3a, 3b, 3c, 8a, 8b, 8c, and 12, however, the combination of balsamic compound and stevia-based sweetener advantageously demonstrated significant, noticeable improvements on overall taste. In addition, the individual taste characteristics, e.g., fullness, aftertaste, roundness, were significantly improved for all examples. And importantly, the balsamic compound/stevia-based sweetener composition provided no loss of sweetness.

Importantly, the Examples show that the surprising results are demonstrated over a wide range of taste modifier compositions concentration. Thus, the full scope of the invention, in its broadest reasonable sense, encompasses simply the synergistic combination of the balsamic compound and the stevia-based sweetener, without regard to compositional concentration ranges. Thus, it is believed that when the balsamic compounds are used in amounts higher (or lower) than those exemplified above, similar benefits will be provided.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that embodiments of the invention and portions of various embodiments and various features recited below and/or in the appended claims may be combined or interchanged either in whole or in part. n the foregoing descriptions of the various embodiments, those embodiments which refer to another embodiment may be appropriately combined with other embodiments as will be appreciated by one of skill in the art.

We claim:

1. A process for modifying the taste features of a stevia-based sweetener in a sweetener/sweetness enhancer composition, the process comprising: adding to the stevia-based sweetener at least one of a compound having a balsamic note and the components thereof to produce a modified sweetener/sweetness enhancer composition.

2. The process of claim 1, further comprising:
determining a threshold limit for the at least one of a compound having a balsamic note and the components thereof relative to a solution comprising the solvent and the at least one of a compound having a balsamic note and the components thereof,
wherein the threshold limit is the amount below which a modifying effect of the at least one of a compound having a balsamic note and the components thereof is undetectable in the solution.

3. The process of claim 2, wherein the adding comprises:
adding the stevia-based sweetener and the at least one of a compound having a balsamic note and the components thereof, in an amount below the threshold amount, to produce the modified sweetener/sweetness enhancer composition.

4. A sweetener/sweetness enhancer composition, comprising:
a stevia-based sweetener; and
at least one of a compound having a balsamic note and the components thereof.

5. The composition of claim 4, wherein the at least one of a compound having a balsamic note and the components thereof is present in an amount ranging from 0.01 wppm to 10 wt %.

6. The composition of claim 4, wherein the composition further comprises a plant extract.

7. The composition of claim 4, wherein the composition further comprises an amino acid.

8. The composition of claim 4, wherein the composition comprises a lactone.

9. A process for making a liquid sweetener/sweetness enhancer composition comprising:
dissolving in a solvent a sweetener/sweetness enhancer composition comprising:
a stevia-based sweetener; and
at least one of a compound having a balsamic note and the components thereof to form the liquid sweetener/sweetness enhancer composition.

10. A process for making a beverage composition comprising:
providing a potable liquid comprising: flavoring and water;
adding to the potable liquid a sweetener/sweetness enhancer composition comprising:
a stevia-based sweetener; and
at least one of a compound having a balsamic note and the components thereof.

11. The process of claim 10, wherein the beverage composition has a pH ranging from 2.5 to 3.3.

12. The process of claim 10, wherein beverage composition comprises the at least one of a compound having a balsamic note and the components thereof in an amount ranging from 0.001 wppb to 110 wppm.

13. A taste modifier composition comprising:
at least one of a compound having a balsamic note and the components thereof, and
a plant extract.

14. The composition of claim 13, wherein the at least one of a compound having a balsamic note and the components thereof is present in an amount ranging from 0.05 wt % to 10 wt %.

15. The composition of claim 13, wherein the composition further comprises an additional component selected from the group consisting of an amino acid, a lactone, an ester having a molecular weight greater than 200, and combinations thereof.

16. The composition of claim 13, further comprising an additional component selected from the group consisting of maltol, a maltol derivative, a carbonyl compound, sodium chloride, trehalose, and combinations thereof.

17. The composition of claim 13, wherein the composition comprises:
the at least one of a compound having a balsamic note and the components thereof present in an amount ranging from 0.05 wt % to 10 wt %;
the plant extract present in an amount ranging from 0.09 wt % to 50 wt %;
an amino acid present in an amount ranging from 0.008 wt % to 0.2 wt %; and
a lactone present in an amount ranging from 0.006 wt % to 0.12 wt %.

18. The composition of claim 13, wherein the composition comprises:
the at least one of a compound having a balsamic note and the components thereof present in an amount ranging from 0.01 wppm to 20 wppm;
the plant extract present in an amount ranging from 0.09 wt % to 50 wt %;
an amino acid present in an amount ranging from 0.008 wt % to 0.2 wt %; and
a lactone present in an amount ranging from 0.006 wt % to 0.12 wt %.

19. The composition of claim 13, wherein the composition comprises:
the at least one of a compound having a balsamic note and the components thereof present in an amount ranging from 0.01 wppm to 20 wppm;
the plant extract present in an amount ranging from 0.09 wt % to 50 wt %;
an ester having a molecular weight greater than 200 present in an amount ranging from 0.001 wt % to 10 wt %; and
a lactone present in an amount ranging from 0.006 wt % to 0.12 wt %.

20. The composition of claim 13, wherein the composition comprises:
the plant extract present in an amount ranging from 0.09 wt % to 50 wt %;
an amino acid present in an amount ranging from 0.008 wt % to 20 wt %;
a lactone present in an amount ranging from 0.006 wt % to 20 wt %;
an ester having a molecular weight greater than 200 present in an amount ranging from 0.001 wt % to 10 wt %;
a bitter blocker present in an amount ranging from 0.15 wt % to 55 wt %;
maltol present in an amount ranging from 0.1 wt % to 85 wt %; and
a carbonyl compound present in an amount ranging from 0.0005 wt % to 10 wt %.
